(19) United States
(12) Patent Application Publication
(10) Pub. No.: US 2004/0249152 A1
(43) Pub. Date: Dec. 9, 2004

(54) Method for the production of cna

(76) Inventors: Dieter Reuschling, Butzbach/Ostheim (DE); Jochen Muller-Ibeler, Diez (DE); Thomas Wagner, Arlington, MA (US); Thomas Krumm, Alfter (DE); Jochen Wermuth, Denkendorf (DE); Marc Pignot, Ebersberg (DE)

Correspondence Address: CONNOLLY BOVE LODGE & HUTZ, LLP, P O BOX 2207, WILMINGTON, DE, 19899, US

(21) Appl. No.: 10/486,597

(22) PCT Filed: Aug. 13, 2002
(86) PCT No.: PCT/EP02/09044

(30) Foreign Application Priority Data
Aug. 13, 2001 (DE) 101 39 730.5

(51) Int. Cl. C07F 9/6512

(52) U.S. Cl. 544/243; 544/244

(57) ABSTRACT

The invention relates to a novel method for the production of CNA oligomers and to artificial supramolecular CNA-p-RNA pairing systems and to the use thereof, especially in biotechnological assays.

The invention relates to a method for the production of CNA oligomers and polymers, and to methods for producing the CNA monomer building blocks required therefor, and to the use of the CNA oligomers for the formation of artificial supramolecular pairing systems, especially in biotechnological assays.

Many new methods based on biochip technology have been able to establish themselves in recent years in the area of clinical diagnosis or in the field of pharmaceutical target and active ingredient screening. Interest to date has been concentrated in particular on DNA chips in order for example to detect the presence of specific nucleic acid sequences in a sample by means of hybridization.

An obvious idea derived from this was to use molecular pairing systems also for the thermodynamically controllable generation of supramolecular assemblies for biotechnological assays as described, for example, in WO 99/15893. For this purpose, in general chemical substances of interest, such as, for example, peptides or proteins, are immobilized on nucleic acid derivatives having specific sequences. Intermediate generation of the desired supramolecular systems is then possible through pairing with nucleic acid fragments having corresponding sequences. If in this case fragments having a known sequence are attached at a defined site on a surface as receptor, spatially resolved addressing of chemical substances attached to a fragment having a complementary sequence is in fact possible.

Naturally occurring nucleic acids such as DNA and RNA are, however, suitable as addressable “carriers” in molecular self-organizing systems only if approximately physiological conditions are maintained. One reason for this is that the chemical stability of naturally occurring nucleic acids, e.g. toward nucleases or basic or acidic conditions, is too low, and another is that their pairing behavior is influenced by method-related factors such as, for example, the salt content and the temperature of the medium, thus greatly restricting the use thereof in biotechnological assays.

For this reason there has been for some time a search for artificial molecular pairing systems suitable for constructing supramolecular architectures and simultaneously tolerating a wide variety of assay conditions.

A pairing system which has been known for a long time is represented by p-RNA oligomers (Helv. Chim. Acta 1993, 76, 2161-2183, Helv. Chim. Acta 1995, 78, 1621-16355, Helv. Chim. Acta 1996, 79, 2316-2345, Helv. Chim. Acta, 1997, 80, 1901-1951, Helv. Chim. Acta, 2000, 83, No. 6, 1079-1107). Owing to their modified sugar-phosphate backbone, specific interaction thereof with biologically active substances such as enzymes, DNA strands or RNA strands is precluded, although the sensitivity of the hybridization of complementary p-RNA oligomers, e.g. toward the salt concentration in a sample medium, still remains a problem on use of p-RNAs as well.

Because of their uncharged peptide backbone, cyclohexyl- or heterocyclohexyl-nucleo-amide oligomers (CNA oligomers), as described in WO 99/15509, in particular represent a suitable alternative to the charged phosphate-containing pairing system. The use of such CNA pairing systems appears to be suitable especially the use thereof in assays in which it is not possible to operate in physiological medium. However, a disadvantage is the highly hydrophobic nature of CNAs, which restricts the possible use thereof in polar solvents such as, for example, water.

In addition, the production, as described in WO 99/15509, of CNA oligomers has to date been difficult. In particular, the complicated multistage synthetic route, particularly because of a complex protective group strategy, and the reaction carried out under drastic conditions, leads to low yields of CNA oligomers. Besides the low yields, the CNA oligomers cannot yet be produced on a larger scale, thus impeding use thereof in biotechnological assays to date. Furthermore, the production of the monomer building blocks necessary for synthesizing CNA oligomers is complicated and possible with only average yields (WO 99/15509), so that the availability of these precursors also impedes the technical use of CNA oligomer products.

It was thus an object to provide a method for CNA oligomerization with which larger amounts of CNA oligomers can be obtained synthetically and with which high yields of CNA oligomer can be achieved.

The object can be achieved by a method for the production of CNA oligomers which includes the following method steps:

a) activation of the carboxyl function of a CNA monomer building block,

b) subsequent esterification of the CNA monomer building block with free hydroxyl groups of a support under basic conditions and

c) thereafter assembly of the oligomer by repetitive cycles starting from elimination of the protective group on the amino group of the cyclohexyl ring of the CNA monomer and subsequent attachment of a further activated CNA monomer, employing CNA monomers of the formula (I)

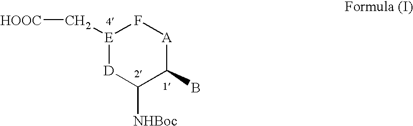

in which A, D and F may be, independently of one another, a —CR³R⁴—, —NR⁵—, —O— or —S— group and E may be a —CR⁶— group, where R³, R⁴, R⁵ or R⁶ may be, independently of one another, a hydrogen atom or a C₁-C₁₂-alkyl group, and in which B is a nucleobase preferably selected from the group of adenine, guanine, cytosine, thymine, uracil, isoguanine, isocytosine, xanthine or hypoxanthine, the primary amino groups of which may be present in unprotected or Boc-protected form. The groups A, D and F are preferably a carbon atom, and the radicals R⁴—R⁶ are preferably hydrogen atoms. Heterocyclic compounds of the formula (I) preferably have at positions A, D and F in total one oxygen atom or one sulfur atom or one to two nitrogen atoms.

It is surprisingly possible for the CNA oligomerization described here, entirely in contrast to conventional DNA or RNA oligomerization methods, to be carried out both with merely Boc-protected and with already base-unprotected CNA monomers. It is thus possible to avoid the final step in the method to eliminate protective groups, normally by treatment of the pMBz-protected oligomers with addition of 2M NaOH at 55° C. for several hours (WO 99/15509). It is thus possible to avoid the large losses of yield resulting due to fragmentation under the harsh pMBz deprotection conditions. The present method of the invention for producing CNA oligomers by contrast proceeds with approximately 100% yield. Since each coupling step proceeds quantitatively, there is no intermediate presence of free cyclohexylamino groups at the end of a synthesis cycle, thus also making the masking of such terminal sequences unnecessary. The synthesis of longer CNA oligomers in larger amounts thus also becomes possible.

It is possible in a preferred embodiment for the synthesis of the CNA oligomers from the appropriate monomer building blocks to be carried out on a solid phase, e.g. on a Tentagel resin (Tentagel S-HMB, Rapp-Polymere) based on the Merrifield peptide synthesis (Merrifield, J. Amer. Chem. Soc. 1963, 85, 2149). For this purpose, initially a solid phase derivatized with a linker such as, for example, a hydroxymethylbenzoyl linker (HMB linker) is employed, and the loading of the support is carried out by activating the carboxyl function of one of the monomer building blocks, e.g. with HATU (N-[(dimethylamino)(3H-1,2,3-triazolo(4,5b)pyridin-3-yloxy)methylene]-N-methylmethanaminium hexafluorophosphate), DIC, TBTU or HBTU and subsequently attaching to the free hydroxyl function of the polymeric support under basic conditions. Subsequent assembly of the oligomer then takes place by repetitive cycles which consist of elimination of a temporary Boc protective group on the amine function of the monomer building block covalently bonded on the cyclohexyl ring to the support, and subsequent attachment of a monomer activated in solution. The preferred coupling times are between 3 to 6 hours. An example of a synthetic scheme is detailed in table 1.

TABLE 1
Scheme for a synthesis cycle to produce CNA oligomers

| Method step | Materials |
|---|---|
| 1. Boc deprotection | e.g. with 50% TFA/CH₂Cl₂ |
| 2. Washing | e.g. with CH₂Cl₂ |
| 3. Neutralization | e.g. with 1 M DIEA/DMF |
| 4. Washing | e.g. with DMF and CH₂Cl₂ |
| 5. Coupling and activation | with Boc-CNA monomer OAc ester |
| 6. Washing | e.g. with DMF and CH₂Cl₂ |

One advantage of this synthesis in this case relates, as already mentioned, to the monomer building blocks which can be employed to assemble a CNA oligomer. Thus, it is advantageous to employ the monomer building blocks merely Boc-protected or even completely unprotected on the nucleobases. In the case of the guanine building block in this connection there is preferably use of the 2-amino function of the nucleobase with Boc protection. The cytosine building block is preferably employed with N⁴-Boc protection on the nucleobase, the adenine building block is preferably used either with N⁶-Boc protection or else unprotected on the nucleobase, and the thymine building block is preferably employed with N³-Boc protection or else unprotected on the nucleobase for the oligomerization. In all cases where the monomer building block is in Boc-protected form, the Boc protective group is removed again directly during the Boc-deprotection step (concerning this, see table 1, method step 1), so that all nucleobases are in unprotected form after each coupling step. If the bases of the CNA monomer building blocks are already in Boc-unprotected form, they can also be employed directly to assemble an oligomer.

Accordingly, preference is given to the use of CNA monomers selected from the group of 3-tert-butoxycarbonyl-1-[(1R,2R,4R)-2-tert-butoxycarbonylamino-4-carboxymethylcyclohex-1-yl]thymine (formula (II)), 1-[(1R,2R,4R)-2-tert-butoxycarbonylamino-4-carboxymethylcyclohex-1-yl]thymine (formula (III)), N⁶-tert-butoxycarbonyl-9-[(1R,2R,4R)-2-tert-butoxycarbonylamino-4-carboxymethylcyclohex-1-yl]adenine (formula (IV)), 9-[(1R,2R,4R)-2-tert-butoxycarbonylamino-4-carboxymethylcyclohex-1-yl]adenine (formula (V)), N⁴-tert-butoxycarbonyl-1-[(1R,2R,4R)-2-tert-butoxycarbonylamino-4-carb-oxymethylcyclohex-1-yl]cytosine (formula (VI)), 1-[(1R,2R,4R)-2-tert-butoxycarbonylamino-4-carboxymethylcyclohex-1-yl]cytosine (formula (VII)), N²-tert-butoxycarbonyl-9-[(1R,2R,4R)-2-tert-butoxycarbonylamino-4-carboxymethylcyclohex-1-yl]guanine (formula (VIII)), 9-[(1R,2R,4R)-2-tert-butoxycarbonylamino-4-carboxymethylcyclohex-1-yl]guanine (formula (IX)).

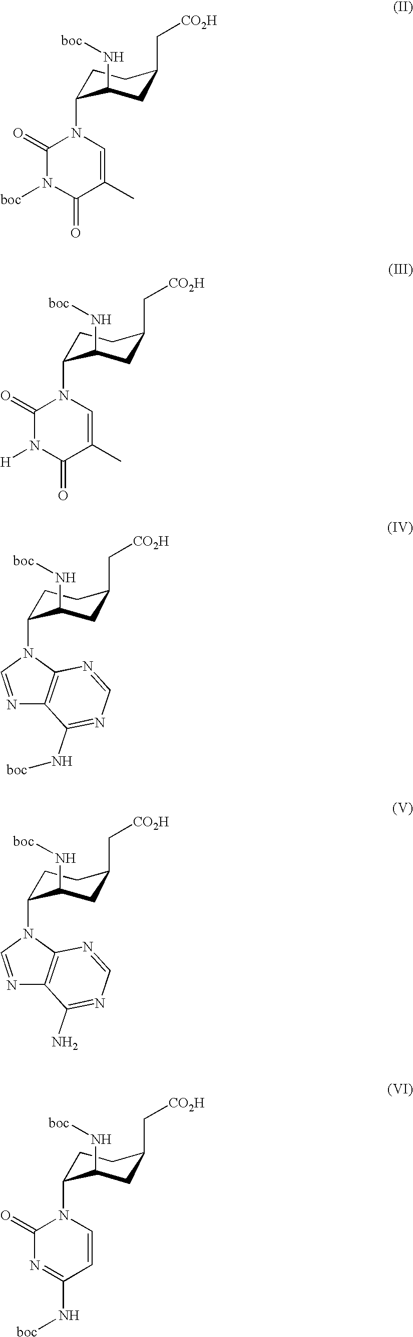

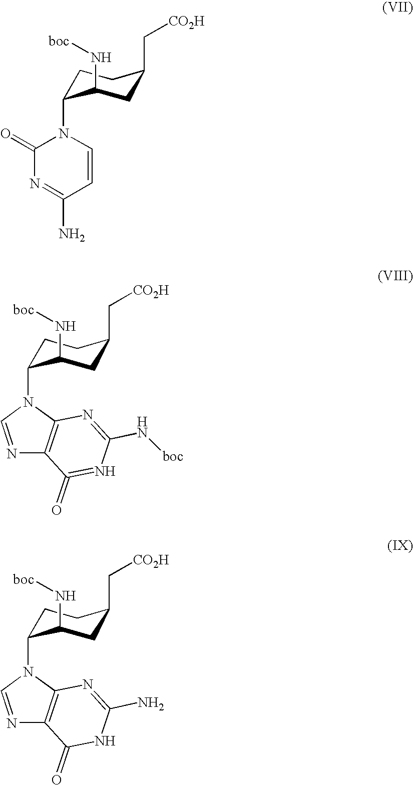

In principle, an oligomerization is possible without taking account of the stereoselectivity of the CNA monomer building blocks, and it is thus possible for example to use racemic mixtures of a CNA monomer or enantiopure CNA monomer building blocks in any sequence as precursor for the oligomerization. However, preference is given to the use of enantiopure or at least enantioenriched CNA oligomers to generate CNA oligomers because, for example, CNA-CNA duplexes or CNA-p-RNA heteroduplexes succeed only with oligomers which have been assembled either from (R)- or (S)-CNA monomer building blocks. The stereoselective production of such CNA oligomers is possible simply through the use of enantiomeric (R)- or (S)-CNA monomers as precursor for the oligomerization.

In order to increase the solubility of the CNA oligomers in polar solvents, especially toward aqueous media, it is possible to introduce hydrophilic groups via suitable linkers. Hydrophilic groups at the N- or C-terminal end of the CNA oligomers additionally permit active transport of these molecules through the application of electric fields, as described for example in U.S. Pat. No. 5,605,662 and in P. N. Gilles et al. [Nature Biotechnology, 17, 365-370 (1990)].

Linkers which have proved useful for introducing N-terminal phosphate groups are, for example, hydroxy carboxylic acid derivatives such as butyric acid (WO 99/15509). The synthesis of phosphorylated CNA oligomers can be greatly simplified, and the yield can be increased, through the use in an improved synthesis variant of a hydroxy carboxylic acid derivative which is already in phosphorylated form. Thus, it is possible for example through the use of phosphorylated butyric acid under the standard coupling conditions used to introduce this group directly in high yields.

A further alternative method for increasing the hydrophilicity of the CNA oligomers is provided by attachment of terminal lysine or oligolysine residues to the C- and/or N-terminal end of the CNA oligomers.

Simple production of CNA-peptide or CNA-protein conjugates which lead to better solubility in polar media is also possible analogously. Such conjugates are, however, of particular interest as functional components in biotechnological assays. Conjugates which comprise antibodies, functional domains thereof, peptide antigens, receptors, structural proteins, glycoproteins or enzymes in particular are of interest for the construction of biochip surfaces.

It is additionally possible to attach many markers, such as, for example, fluorescent dyes, radiolabeled amino acids or biotin, to the terminal ends of the CNA oligomers.

The present invention further relates to an advantageous method for the production of CNA monomers which are particularly suitable for the oligomerization and which can be used directly for carrying out the described oligomerization. Besides the possibility of direct use of the CNA monomer products for the oligomerization, a further advantage of the synthesis of the invention is the high yield thereof, based on an improved protective group strategy.

In the method of the invention for the production of CNA monomers, in a first step an iodolactam of the formula (XIII)

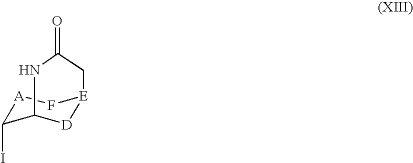

in which A, D and F can be, independently of one another, a —CR³R⁴— group and E can be a —CR⁶— group, where R³, R⁴ or R⁶have the abovementioned meaning, the iodolactam preferably being 8-iodo-2-azabicyclo[3.3.1]nonan-3-one, is coupled to a nucleobase in the presence of a base. Examples of suitable bases are organic bases such as DBU, DBN, or carbonates such as alkali metal and alkaline earth metal carbonates, and preferred bases are NaH, OBu and K₂CO₃. NaH is particularly preferably employed as base in a molar ratio of 1:1 relative to the lactam.

Suitable as nucleobase for this purpose are thymine, preferably its lithium salt, adenine, N⁶-benzoyladenine, N⁶-dimethylaminoethyleneadenine, cytosine, N⁴-benozylcytosine or 2-amino-6-chloropurine. The secondary amine group of the lactam ring is then BOC-protected. It is also possible in this case for the other primary and secondary amine groups of the base to be BOC-protected. A targeted previous protection of the amino functions of the base portion of the monomer with other protective groups is surprisingly unnecessary. Consequently, the required elimination of these protective groups is also dispensed with.

After introduction of the BOC protective group on N² of the lactam, the ring is cleaved with a lithium salt, preferably with lithium hydroxide monohydrate, to give the desired CNA monomer. To synthesize the guanine building block it is necessary for the chlorine substituent of the purine to be converted into a carbonyl group before the lactam cleavage.

The CNA monomers produced in this way can be used without further derivatization directly in the CNA oligomer synthesis. The present invention thus further relates to CNA monomers whose 2-amino function of the cyclohexane ring is singly Boc-protected, and whose nitrogen atoms of the base portion are in unprotected or partially Boc-protected form. Particularly preferred CNA monomers are those from the group of 3-tert-butoxycarbonyl-1-[(1R,2R,4R)-2-tert-butoxycarbonylamino-4-carboxymethylcyclohex-1-yl]thymine, 1-[(1R,2R,4R)-2-tert-butoxycarbonylamino-4-carboxymethylcyclohex-1-yl]-thymine, 9-[(1R,2R,4R)-2-tert-butoxycarbonylamino-4-carboxymethylcyclohex-1-yl]adenine, N⁶-tert-butoxycarbonyl-9-[(1R,2R,4R)-2-tert-butoxycarbonylamino-4-carboxymethylcyclohex-1-yl]adenine, N⁴-tert-butoxycarbonyl-1-[(1R,2R,4R)-2-tert-butoxycarbonylamino-4-carboxymethylcyclohex-1-yl]cytosine, 1-[(1R,2R,4R)-2-tert-butoxycarbonylamino-4-carboxymethylcyclohex-1-yl]cytosine, N²-tert-butoxycarbonyl-9-[(1R,2R,4R)-2-tert-butoxycarbonylamino-4-carboxymethylcyclohex-1-yl]guanine, 9-[(1R,2R,4R)-2-tert-butoxycarbonylamino-4-carboxymethylcyclohex-1-yl]guanine.

Using the method of the invention for CNA oligomerization it is possible to provide CNA oligomers in sufficient amount for them to be employed for example as pairing system in biotechnological assays.

It can surprisingly be shown in this connection that CNA oligomers pair together very specifically with p-RNA oligomers having a complementary sequence and form supramolecular heteroduplexes whose chemical properties and structure are scarcely influenced by biological samples. Thus, the single strands of the heteroduplex do not pair with DNA, RNA or PNA. Complementary CNA and p-RNA form in the heteroduplex a ladder structure which is more stable than the naturally occurring nucleic acids and whose specific pairing depends less on external factors such as, for example, on the solvent used. From this, a very good thermodynamic control of the hybridization and dehybridization takes place in a wide variety of media and, in particular, the control can be exerted independently of naturally occurring association processes. The high stability of the intermolecular binding of the CNA oligomers with their complementary p-RNA oligomers allows even relatively short sequences still to pair together sequence-specifically. There is also a contribution to this from the fact that the stability of CNA oligomers with their complementary p-RNA oligomers is greatly reduced by base mismatches. In addition, p-RNA and CNA pair exclusively in the Watson-Crick mode, thus increasing the selectivity thereof. A further advantage of CNA oligomers is the possibility of using them in media with low salt concentration, because even then a thermodynamically stable selective pairing with complementary p-RNA oligomers takes place. In addition, the CNA oligomers stabilize a CNA-p-RNA heteroduplex at elevated temperatures and in basic and acidic media.

Because of the artificial oligomer backbone and the linear ladder structure, CNA-p-RNA heteroduplex molecules are not enzymatically degraded and the association of biological molecules which bind double-stranded nucleic acids, such as, for example, histones, transcription factors, repressors, ribosomes etc., is minimized.

It is thus now possible to utilize pairing systems adapted according to the assay conditions and composed of CNA-CNA, p-RNA-p-RNA homoduplexes or CNA-p-RNA heteroduplexes.

Suitable cyclohexyl- or heterocyclohexyl-nucleo-amide oligomers (CNA oligomers) as are suitable for the formation of CNA-p-RNA heteroduplexes comprise a peptide cyclohexylamide backbone as depicted by way of example in structural formula (X).

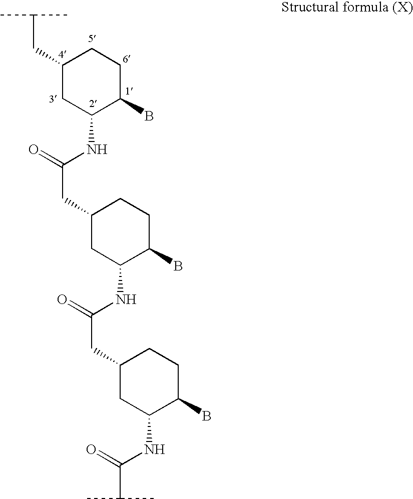

B in structural formula (X) represents any nucleobases such as, for example, adenine, guanine, cytosine, thymine, uracil, isoguanine, isocytosine, xanthine or hypoxanthine. The nucleobases are bonded in the 1′ position to the cyclohexyl radical. The cyclohexyl or heterocyclohexyl radicals are linked together by 2′-4′-amide linkages to give a CNA oligomer. In principle, a stereochemically regular CNA oligomer structure is advantageous for pairing with p-RNA oligomers, there being hybridization of (S)-CNA oligomers with (L)-p-RNA and (R)-CNA oligomers with (D)-p-RNA.

A large number of monomeric cyclohexyl- or heterocyclohexyl-nucleo-amine building blocks (CNA monomers) which can be used to assemble corresponding oligomers (structural formula (XI)) and methods for the production thereof are described in WO 99/15509.

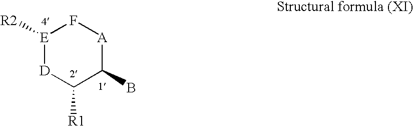

B in structural formula (XI) is a nucleobase and R1 is an NH₂ group. R2 is a CH₂—COOH group. A, D and F may be independently of one another a —CR³R⁴—, —NR⁵—, —O— or —S— group and E is a —CR⁶— group, where R³, R⁴, R⁵ or R⁶ can be independently of one another a hydrogen atom or a C₁-C₁₂ alkyl group. CNA monomers in which the radicals R³ and R⁴ are hydrogen atoms are particularly preferred.

p-RNA oligomers like those described for example in (Helv. Chim. Acta 1993, 76, 2161-2183, Helv. Chim. Acta 1995, 78, 1621-1635, Helv. Chim. Acta 1996, 79, 2316-2345, Helv. Chim. Acta, 1997, 80, 1901-1951) are suitable for the formation of heteroduplexes of the invention. The p-RNA oligomers may likewise be modified, so that p-RNA conjugates which may comprise peptides, proteins or markers known to the skilled worker are produced. Linkers like those described in DE 197 41 738 A1 are preferably used in the production of such conjugates.

The described CNA oligomers can hybridize with p-RNA oligomers to give heteroduplexes as shown by way of example in structural formula (XII), where B and B′ are each mutually complementary bases.

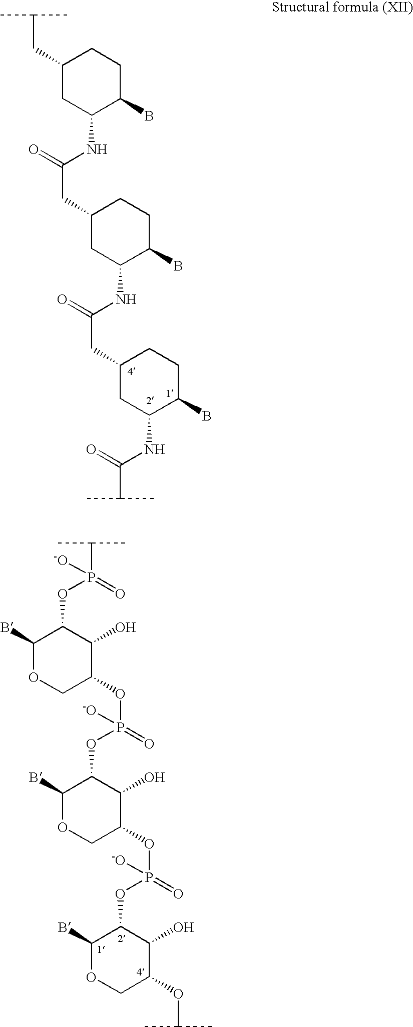

The CNA-p-RNA heteroduplexes have relatively high melting points, meaning that the pairing is relatively stable. Thus, even short oligomers such as, for example, 5-mers can form stable heteroduplexes in aqueous solution. However, heteroduplexes composed of 7- to 12-mers are preferred. There is, of course, nothing preventing the use of longer oligomer for heteroduplex formation.

It can additionally be shown that the CNA-p-RNA heteroduplex formation is quite high even on use of short CNA and p-RNA oligomers under low-salt conditions. Working under low-salt conditions is important in particular for biotechnological methods, because the salt concentration greatly influences the conformation and the activity of biological substances such as, for example, of DNA or of proteins. The addition of cations to saturate the negative charges on the duplex can be minimized through the variation of CNA-CNA and CNA-p-RNA pairing systems.

Exemplary Embodiments

General Preliminary Remarks on the Exemplary Embodiments

All the pure solvents used (Fluka) are stored over molecular sieves and used without further purification.

The oligomerization by means of solid phase synthesis is carried out using a “TentaGel S HMB” resin (Rapp Polymere) with a capacity of 0.23 mmol/g. The reactions are carried out in a Chirana syringe (5 ml volume for an amount of more than 100 mg of resin or 2 ml volume for an amount of less than 100 mg of resin) with a fritted filter insert.

The HPLC investigations are carried out with a Beckman System Gold™ chromatography system with programmable “126” solvent module and a “168” diode array UV/Vis detector module.

The RP-HPLC is carried out on the analytical scale using a LiChrospher C-18 Hibar column (5 μm, 4×250 mm, Merck) at a flow rate of 1 ml/min and on the semipreparative scale using a LiChrospher C-18 column (10 μm, 4×250 mm, Merck) at a flow rate of 1 ml/min.

The following solvents used for the elution: eluent A: water, 0.1% TFA (v/v); eluent B: MeCN, 0.1% TFA (v/v).

The following gradients of eluent A and eluent B solvents are chosen for the analytical HPLC runs:

method A: continuous increase in the proportion of eluent B solvent from 10% to 60% within 30 min;

method B: continuous increase in the proportion of eluent B solvent from 10% to 40% within 30 min;

method C: continuous increase in the proportion of eluent B solvent from 10% to 30% within 40 min.

The following gradient of eluent A and eluent B solvents is chosen for the semipreparative HPLC runs:

method D: continuous increase in the proportion of eluent B solvent from 10% to 40% within 30 min.

The UV data indicated in the exemplary embodiments were obtained using a Jasco V-530 UV/Vis spectrophotometer, the CD spectra were recorded using a Jasco J710 spectropolarimeter, and the melting curves (Tm curves) were determined by UV measurement using a Perkin-Elmer Lambda-2 UV/Vis spectrophotometer equipped with a temperature-controllable quartz cuvette holder and a fitted microthermoelement (Keithley Instruments DAS-801-AT-Bus DAQ board (Quick-Basic 4.0 driver)) which can be introduced into the measuring cuvette.

Measurement of the Tm curves takes place with a temperature gradient between 5° and 90° C. at a heating or cooling rate of 1° C./40 s. The samples are for this purpose dissolved in degassed Tris-HCl buffer (5 mM; pH 7.0) and put into the quartz cuvettes (10×10 mm, 1×10 mm, Hellma; d=10 or d=1). MicroCal origin software using a polynomial regression (600 points, 9th order) is employed to evaluate the measured data.

The mass spectra were recorded using an electrospray ionization mass spectrometer (ESI-MS) (Finnigan LCQ ion trap MS (Finnigan, USA)) with an MeCN/water (1:1) mixture containing 0.1% TFA as solvent.

Synthesis of the Monomer Building Blocks

(R)-Thymine Building Block

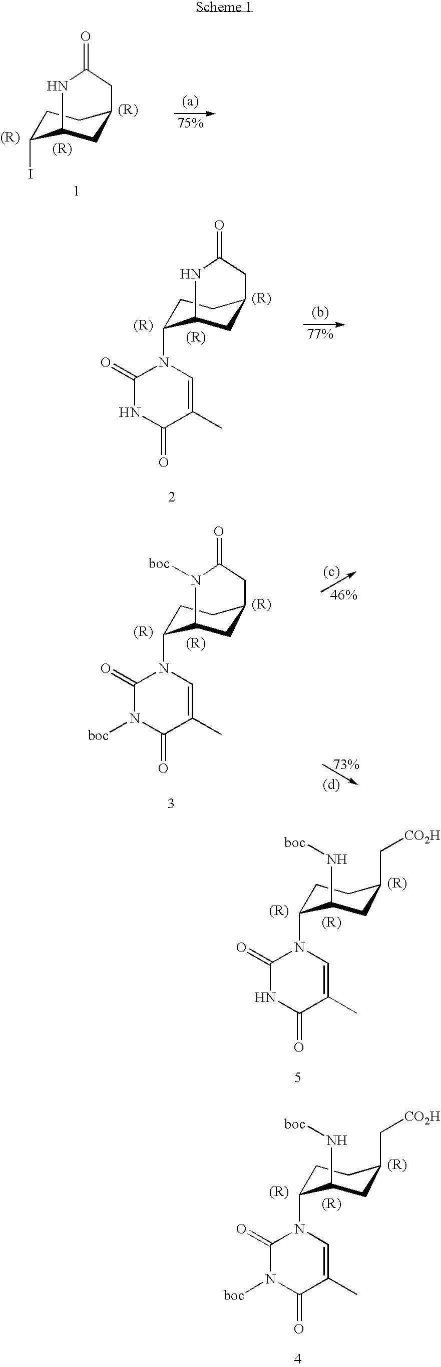

(a) NaH, Li salt of thymine, DMF, 0° C./RT-(b) (BOC)₂O. TEA, DMAP, CH₂Cl₂-(c) LiOH, THF/H₂O/CH₃OH, 0° C./RT-(d) LiO₂H, THF/H₂O/CH₃OH, 0° C./RT

### EXAMPLE 1

1-[(1R,5R,8R)-3-Oxo-2-azabicyclo[3.3.1]nonan-8-yl]thymine 2

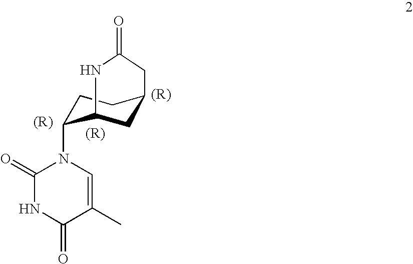

1.26 g (10 mmol) of thymine are introduced into 50 ml of THF at 0° C., and 4 ml (10 mmol) of 2.5M butyllithium in hexane are cautiously added. After the solution has been stirred for 10 minutes, the THF is distilled off in vacuo, and the residue (monolithium salt of thymine) is taken up in 10 ml of DMF. 0.4 g (10 mmol) of NaH (60%) is introduced into a second flask and, at 0° C., 2.65 g (10 mmol) of (1R,5R,8R)-8-iodo-2-azabicyclo[3.3.1]nonan-3-one 1 are added. Evolution of H₂ has ceased after about 30 min, and the above lithium salt solution can be added. The mixture is then stirred at room temperature overnight (about 16 h). The solvent is distilled off in vacuo, and the residue is dissolved in water and put on an XAD-16 column; firstly the inorganic constituents are removed (including unreacted thymine) with water and then the organic product is dissolved off the column with methanol. Evaporation of the methanol fractions results in a residue which is purified further by stirring in methylene chloride and then filtering off with suction. (1.33 g)

A further amount of product can be isolated from the mother liquor by chromatography (EtOAc/CH₃OH=5:1). (0.65 g) 1.98 g (75%)

Melting point >300° C. (decomposition)

R_{F}=0.55 (acetone:CH₂Cl₂:CH₃OH:EtOAc:H₂O:AcOH=9:6:2:2:2:1)

HPLC: >98% [Cyclobond I, CH₃CN/(H₂O+0.01N TBAS)=80:20] [α]_{D}²²=+55.5° (c=0.5; CH₃OH)

¹H-NMR (400 mHz, d₆-DMSO) 1.52-1.65 (m, 3H); 1.80-1.88 (m, 4H); 1.96-2.12 (m, 3H); 2.16-2.23 (m, 1H); 2.40-2.48 (m, 1H); 3.61 & 4.17 (2m, 2H, CH—[NH] & CH—N); 7.52 (d, 1H, ═CH); 7.94 (d, 1H, NH—CO); 11.27 (s, 1H, CO—NH—CO)

### EXAMPLE 2

1-[(1R,5R,8R)-3-Oxo-2-azabicyclo[3.3.1]nonan-8-yl]thymine 2

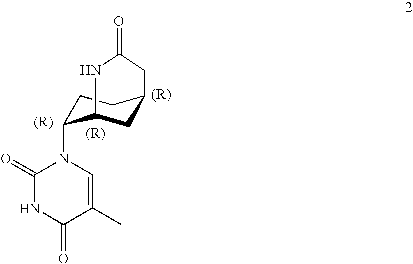

1.26 g (10 mmol) of thymine, 2.65 g (10 mmol) of (1R,5R,8R)-8-iodo-2-azabicyclo[3.3.1]nonan-3-one 1 and 3.5 g (25 mmol) of K₂CO₃ in 50 ml of DMSO are stirred at room temperature for 48 h. For workup, firstly the DMSO is distilled off in vacuo, and the residue is boiled with tetrachloromethane. The remaining residue is dissolved in water and put on an XAD-16 column; firstly the inorganic constituents are removed (including unreacted thymine) with water and then the organic product is dissolved off the column with methanol. Evaporation of the methanol fractions results in a residue which is purified further by chromatography, (SiO₂:EtOAc/EtOH=5:1)

1.0 g (38%)

See example 1 for physical data

### EXAMPLE 3

3-tert-Butoxycarbonyl-1-[(1R,5R,8R)-3-oxo-2-tert-butoxycarbonyl-2-azabicyclo[3.3.1]nonan-8-yl]thymine 3

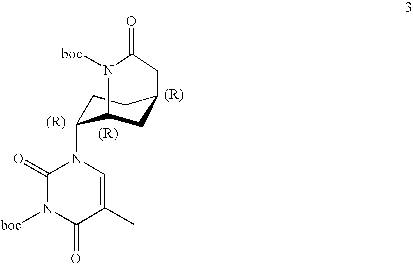

2.1 g (8 mmol) of 1-[(1R,5R,8R)-3-oxo-2-azabicyclo[3.3.1]nonan-8-yl]thymine 2, 1.38 ml (10 mmol) of triethylamine, 4.36 g (20 mmol) of di-tert-butyl pyrocarbonate and 50 mg of DMAP are boiled under reflux in 50 ml of methylene chloride for about 4 h and left to stand at room temperature overnight. (TLC check: EtOAc) When the reaction is complete, 50 ml of water are added and vigorously stirred for about 10 min. The organic phase is then separated off, the aqueous phase is extracted with methylene chloride, the combined organic phases are dried, and the solvent is evaporated off. The residue is purified by column chromatography. (SiO₂, EtOAc)

2.85 g (77%)

Melting point 116° C.

R_{F}=0.41 (EtOAc)

HPLC: >98% [LiChrospher RP 18, CH₃CN/(H₂O+0.01N TBAS)=75:25] [α]_{D}²²=+5.75° (c=0.38; CH₃OH)

¹H-NMR (400 mHz, d₆-DMSO) 1.34 & 1.43 (2s, 18H, 2 tert-Bu); 1.34-1.36 (m, 1H); 1.67-1.83 (m, 6H); 1.90-2.08 (m, 2H); 2.13-2.26 (m, 2H); 2.57-2.69 (m, 1H); 4.22 & 4.30 (2m, 2H, CH—[NH] & CH—N); 7.56 (d, 1H, ═CH)

### EXAMPLE 4

3-tert-Butoxycarbonyl-1-[(1R,2R,4R)-2-tert-butoxycarbonylamino-4-carboxymethylcyclohex-1-yl]thymine 4

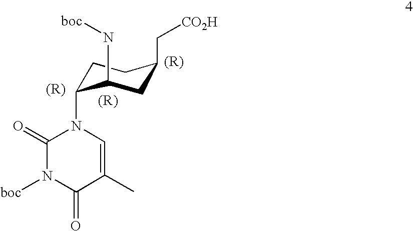

1.5 g (36 mmol) of lithium hydroxide monohydrate are dissolved in 25 ml of water and, at 0° C., 3.1 ml (36 mmol) of H₂O₂ (35%) are added. Then 5.6 g (12 mmol) of 3-tert-butoxycarbonyl-1-[(1R,5R,8R)-3-oxo-2-tert-butoxycarbonyl-2-azabicyclo[3.3.1]nonan-8-yl]thymine 3 dissolved in 165 ml of THF are added dropwise at 0° C.; thereafter 50 ml of methanol are added and the mixture is stirred at room temperature for about 18 h. If peroxides are still present in the solution, they are destroyed with a little Na₂SO₃ solution; THF/CH₃OH is then distilled off in vacuo, water and methylene chloride are added to the remaining aqueous phase, and the mixture is adjusted to pH 3 with dilute HCl, the organic phase is separated off, and the aqueous phase is extracted with methylene chloride. Drying and distilling off the solvent result in a residue which is purified by chromatography. (SiO₂, EtOAc)

4.2 g (73%)

RF=0.71 (EtOAc/CH₃OH=5:1)

HPLC: 96% [Cyclobond I, CH₃CN/(H₂O+0.01N TBAS)=92.5:7.5] [α]_{D}²²=+24.8° (c=0.56; CH₃OH)

¹H-NMR (400 mHz, CDCl₃) 1.05-1.25 (m, 2H); 1.32 & 1.59 (2s, 18H, 2 tert-Bu); 1.57-1.68 (m, 1H); 1.80-2.08 (m, 3H); 1.91 (s, 3H, CH₃); 2.10-2.23 (m, 1H); 2.22-2.37 (m, 2H); 3.86 & 4.33 (2m, 2H, CH—[NH] & CH—N); 4.73 (d, 1H, HN—CO); 7.15 (s, 1H, ═CH); approx. 10.0 (broad s, 1H, CO₂H)

### EXAMPLE 5

1-[(1R,2R,4R)-2-tert-Butoxycarbonylamino-4-carboxymethylcyclohex-1-yl]thymine 5

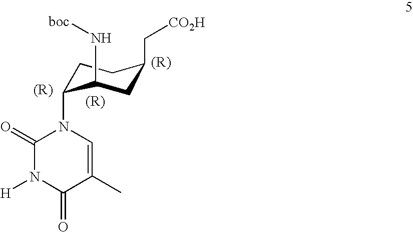

9.3 g (20 mmol) of 3-tert-butoxycarbonyl-1-[(1R,5R,8R)-3-oxo-2-tert-butoxycarbonyl-2-aza-bicyclo[3.3.1]nonan-8-yl]thymine 3 are introduced into 450 ml of THF and, at −10° C., a solution of 4.2 g (100 mmol) of lithium hydroxide monohydrate in 100 ml of water is added dropwise over the course of 30 min. Then 70 ml of methanol are added and the mixture is stirred at −10° C. until starting material is no longer present. (about 5 h; TLC check: EtOAc) It is then stirred at room temperature for 12 h and at 45-55° C. for 15-20 h. (TLC check: CH₂Cl₂/CH₃OH=5:1). The solvent THF/CH₃OH is distilled off in vacuo, and the aqueous residue is adjusted to pH 3 with dilute HCl and extracted with methylene chloride. The organic phase is dried, and evaporated, and the residue is purified by chromatography. (SiO₂:CH₂Cl₂/CH₃OH=5:1)

35 g (46%)

Melting point 245° C. decomp.)

R_{F}=0.36 (CH₂Cl₂/CH₃OH=5:1)

HPLC: 98.7% [LiChrosopher RP 18, CH₃CN, (H₂O+0.01N TBAS) as gradient (from 90% to 600% in 30 min), flow 1 ml/min] [α]_{D}²²=22.26° (c=0.57; CH₃OH)

¹H-NMR (400 mHz, d₆-DMSO) 1.3-1.32 (m, 2H); 1.26 (s, 9H, tert-Bu); 1.63-1.94 (m, 5H); 1.73 (s, 3H, CH₃); 2.06-2.21 (m, 2H); 3.75 (m, 1H, CH—[NH]); 4.18 (m, 1H, CH—N); 6.74 (d, 1H, NH-boc); 7.55 (s, 1H, —CH═); 11.06 (s, 1H, CO—NH—CO); 12.05 (s, 1H,

(R)-Adenine building block

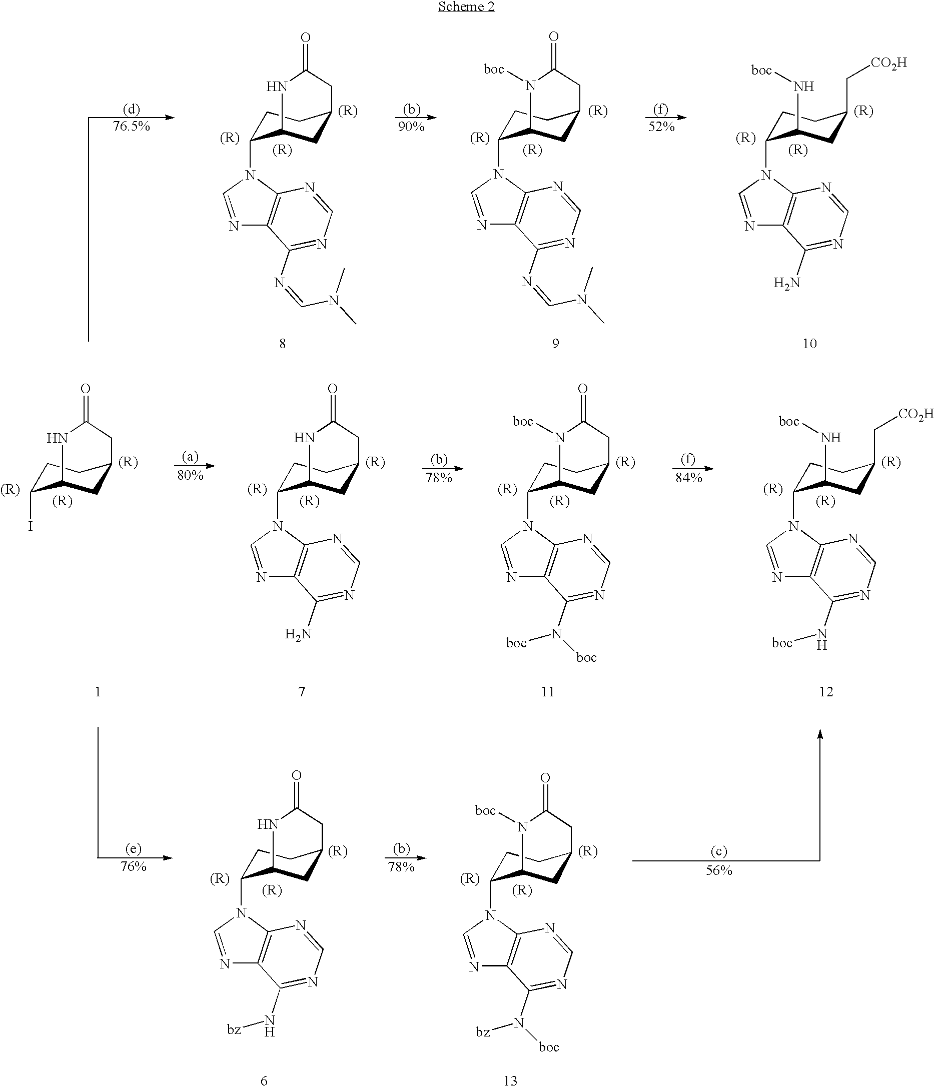

(a) NaH, adenine, DMF, 0° C./RT-(b) (Boc)₂O, TEA, DMAP, CH₂Cl₂-(c) LiOH, THF/H₂O/CH₃OH, −10° C./RT-(d) NaH, N⁶-dimethylaminomethyleneadenine, DMF, 0° C./RT-(e) NaH, N⁶-benzoyladenine, DMF, 0° C./RT-(f) LiOH, CH₃OH/H₂O, −15° C. then RT

### EXAMPLE 6

N⁶-Benzoyl-9-[(1R,5R,8R)-3-oxo-2-azabicyclo[3.3.1]nonan-8-yl]adenine 6

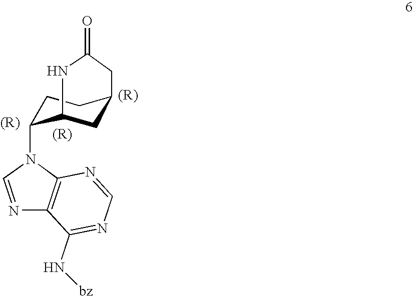

0.4 g (10 mmol) of NaH (60%) is introduced into 50 ml of DMF at 0° C., and 2.65 g (10 mmol) of (1R,5R,8R)-8-iodo-2-azabicyclo[3.3.1]nonan-3-one 1 are added. Evolution of H₂ has ceased after about 30 min, and 2.4 g (10 mmol) of N⁶-benzoyladenine can be added. The cooling is then removed, and the mixture is stirred at room temperature overnight (about 15 h). The DMF is then distilled off in vacuo, the residue is taken up in about 100 ml of water, and the reaction product is extracted several times with methylene chloride. The organic phase is washed with saturated brine, dried and evaporated. The solid residue is taken up in isopropanol, and remaining solid product is filtered off with suction. [0.4 g (17%) of N⁶-benzoyladenine] The filtrate is evaporated and chromatographed. (SiO₂: firstly EtOAc/CH₃OH=5.1 then CH₂Cl₂/CH₃OH=5:1)

2.85 g (75.8%)

Melting point >300° C.

R_{F}=0.57 (CH₂Cl₂/CH₃OH=5:1) [α]_{D}²²=−35.1° (c=1.1; CH₃OH)

HPLC: 94% [Cyclobond I, CH₃CN/(H₂O+0.01N TBAS)=90:10]

¹H-NMR (400 mHz, d₆-DMSO) 1.52-1.74 (m, 3H); 2.05-2.34 (m, 5H); 2.48-2.56 (m, 1H); 4.25 & 4.62 (2m, 2H, CH—[NH] & CH—N); 7.52-8.07 (m, 5H, Ph); 8.11 (d, 1H, HN-[CH]); 8.68 & 8.75 (2s, 2H, 2-CH═); 11.15 (s, 1H, NH—CO)

### EXAMPLE 7

N⁶-(Dimethylaminomethylene)-9-[(1R,5R,8R)-3-oxo-2-azabicyclo-[3.3.1]nonan-8-yl]adenine 8

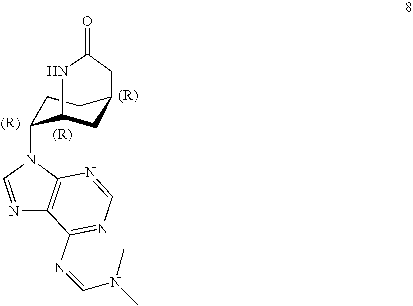

0.8 g (20 mmol) of NaH (60%) is introduced into 100 ml of DMF at 0° C., and 5.3 g (10 mmol) of (1R,5R,8R)-8-iodo-2-azabicyclo[3.3.1]nonan-3-one 1 are added. Evolution of H₂ has ceased after about 30 min, and 3.8 g (20 mmol) of N⁶-(dimethylaminomethylene)adenine can be added. The cooling is then removed, and the mixture is stirred at room temperature for about 48 h. The DMF is then distilled off in vacuo, and the residue is taken up in water and put on an XAD 16 column to remove inorganic constituents; after washing with water, the product is dissolved off the column with methanol. The residue after evaporation of the solvent is purified by chromatography. (SiO₂:CH₂Cl₂/CH₃OH=5:1)

5 g (76.5%)

R_{F}=0.24 (CH₂Cl₂/CH₃OH=10:1) [α]_{D}²²=−81° (c=0.4; CH₃OH)

HPLC: >98% [Cyclobond I, CH₃CN/(H₂O+0.01N TBAS)=80:20]

¹H-NMR (400 mHz, d₆-DMSO) 1.45-1.74 (m, 3H); 2.02-2.29 (m, 5H); 2.46-2.55 (m, 1H); 3.12 & 3.18 (2s, 6H, 2CH₃); 4.22 & 4.51 (2m, 2H, CH—[NH]& CH—N); 8.05 (d, 1H, HN—[CH]); 8.42 & 8.44 (2s, 2H, 2-CH═); 8.92 (s, 1H, N═CH—N)

### EXAMPLE 8

9-[(1R,5R,8R)-3-Oxo-2-azabicyclo[3.3.1]nonan-8-yl]adenine 7

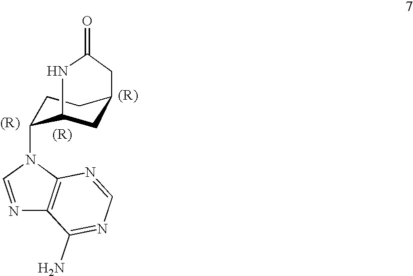

0.8 g (20 mmol) of NaH (60%) is introduced into 50 ml of DMF at 0° C., and 5.3 g (20 mmol) of (1R,5R,8R)-8-iodo-2-azabicyclo[3.3. 1]nonan-3-one 1 are added. Evolution of H₂ has ceased after about 30 min, and 2.3 g (20 mmol) of adenine can be added. The cooling is then removed, and the mixture is stirred at room temperature overnight (about 15 h). The DMF is then distilled off in vacuo, and the residue is dissolved in about 100 ml of water and extracted several times with ethyl acetate to remove by-products; the aqueous phase is boiled with about 5 g of NaHCO₃ and, cooled, put on an XAD 16 column; firstly the inorganic salts are washed off the column with water and then the reaction product with methanol. The residue after evaporation of the methanol phases is boiled once in ethyl acetate, cooled and filtered off with suction.

4.4 g (80%)

Melting point >300° C.

R_{F}=0.6 (CH₂Cl₂/CH₃OH=5:1) [α]_{D}²²=−43° (c=0.4; CH₃OH)

HPLC: 98% [Cyclobond I, CH₃CN/(H₂O+0.01N TBAS)=70:30]

¹H-NMR (400 mHz, d₆-DMSO) 1.47-1.73 (m, 3H); 2.04-2.28 (m, 5H); 2.47-2.56 (m, 1H); 4.22 & 4.48 (2m, 2H, CH—[NH] & CH—N); 7.30 (s, 2H, NH₂); 8.13 (d, 1H, HN—CO); 8.16 & 8.37 (2s, 2H, 2-CH═)

### EXAMPLE 9

9-[(1R,5R,8R)-3-Oxo-2-azabicyclo[3.3.1]nonan-8-yl]adenine 7

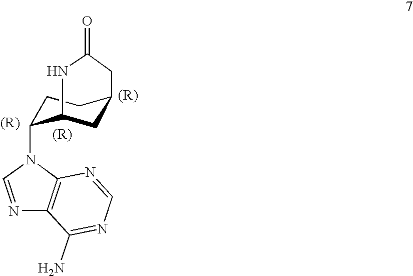

1.35 g (10 mmol) of adenine, 2.65 g (10 mmol) of (1R,5R,8R)-8-iodo-2-azabicyclo[3.3.1]nonan-3-one 1 and 2.1 g (15 mmol) of potassium carbonate are stirred in 50 ml of dimethyl sulfoxide at room temperature for 2 days. The dimethyl sulfoxide is then largely distilled off under good vacuum at moderate temperature, and the residue is taken up in water and put on an XAD 16 column. The inorganic constituents can be washed out together with unreacted adenine with water; the prepurified reaction product is then washed off the column with methanol. The residue from the methanol phase is purified by chromatography. (SiO₂: CH₂Cl₂/CH₃OH=5.1) 2.0 g (73%)

See example 8 for physical data

### EXAMPLE 10

N⁶-Benzoyl-N⁶-tert-butoxycarbonyl-9-[(1R,5R,8R)-3-oxo-2-tert-butoxycarbonyl-2-azabicyclo[3.3.1]nonan-8-yl]adenine 13

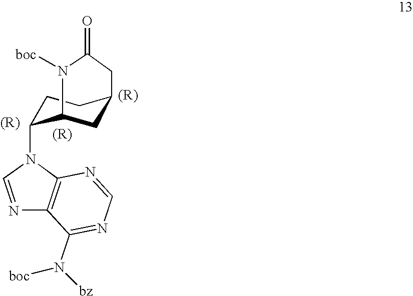

1.88 g (5 mmol) of N⁶-benzoyl-9-[(1R,5R,8R)-5-oxo-2-azabicyclo[3.3.1]nonan-8-yl]adenine 6, 3.27 g (15 mmol) of di-tert-butyl pyrocarbonate and 100 mg of DMAP are stirred in 50 ml of acetonitrile at room temperature for 24 h. The residue after evaporation of the solvent is chromatographed. (SiO₂: EtOAc)

2.14 g (74.2%)

R_{F}=0.77 (EtOAc/CH₃OH=5.1)

¹H-NMR (400 mHz, d₆-DMSO) 1.25 & 1.52 (2s, 18H, 2-tert-Bu); 1.61-1.92 (m, 3H); 2.02-2.15 (m, 2H); 2.20-2.28 (m, 1H); 2.31-2.45 (m, 2H); 2.76-2.88 (m, 1H); 4.89 & 5.15 (2m, 2H, CH—[NH] & CH—N); 7.52-7.81 (m, 5H, Ph); 8.87 & 8.88 (2s, 2H, 2-CH═)

### EXAMPLE 11

N⁶-Di(tert-butoxycarbonyl)-9-[(1R,5R,8R)-3-oxo-2-tert-butoxycarbonyl-2-azabicyclo[3.3.1]nonan-8-yl]adenine 11

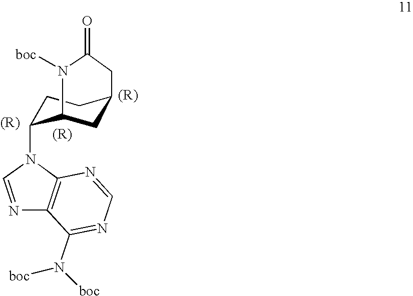

10 g (36.7 mmol) of 9-[(1R,5R,8R)-3-oxo-2-azabicyclo[3.3.1]nonan-8-yl]adenine 7 in 350 ml of methylene chloride are mixed with 5.08 ml (36.7 mmol) of TEA, 32 g (147 mmol) of di-tert-butyl pyrocarbonate and 200 mg of DMAP at room temperature and then stirred under reflux for about 4 h. (TLC check: CH₂Cl₂/CH₃OH=5:1) The residue after distilling off the solvent is purified by column chromatography. (SiO₂:EtOAc)

16.3 g (77.5%)

R_{F}=0.58 (EtOAc)

[α]_{D}²²=−49.5° (c=1.1; CH₃OH)

HPLC: 98% [Cyclobond I, CH₃CN]

¹H-NMR (400 mHz, CDCl₃) 1.48 & 1.61 (2s, 27H, 3-tert-Bu); 1.76-1.95 (m, 3H); 2.15-2.45 (m, 4H); 2.50-2.57 (m, 1H); 2.80-2.90 (m, 1H); 4.93 & 5.25 (2m, 2H, CH—[NH] & CH—N); 8.32 & 8.87 (2s, 2H, 2-CH═)

### EXAMPLE 12

N⁶-(Dimethylaminomethylene)-9-[(1R,5R,8R)-3-oxo-2-tert-butoxycarbonyl-2-azabicyclo[3.3.1]nonan-8-yl]adenine 9

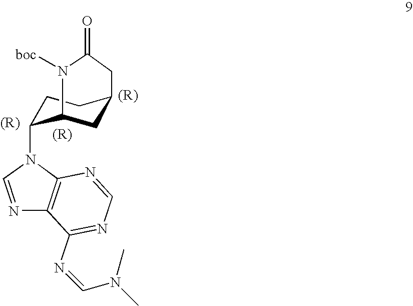

5 g (13.4 mmol) of N⁶-(dimethylaminomethylene)-9-[(1R,5R,8R)-3-oxo-2-azabicyclo[3.3.1]nonan-8-yl]adenine 8 are stirred into 250 ml of methylene chloride with 1.86 ml of TEA, 5.85 g (26.8 mmol) of di-tert-butyl pyrocarbonate and 20 mg of DMAP at room temperature for about 60 h. The residue after evaporation of the solvent is chromatographed.

(SiO₂:EtOAc/CH₃OH=5:1)

5 g (87.5%)

R_{F}=0.23 (EtOAc/CH₃OH=5:1)

¹H-NMR (400 mHz, CDCl₃) 1.6 (s, 9H, tert-Bu); 1.75-2.56 (m, 8H); 2.78-2.89 (m, 1H); 3.22 & 3.27 (2s, 6H, 2CH₃); 4.87 & 5.30 (2m, 2H, CH—[NH] & CH—N); 8.12 & 8.54 (2s, 2H, 2-CH═); 8.95 (s, 1H, N═CH—N)

### EXAMPLE 13

N⁶-tert-Butoxycarbonyl-9-[(1R,2R,4R)-2-tert-butoxycarbonylamino-4-carboxymethylcyclohex-1-yl]adenine 12

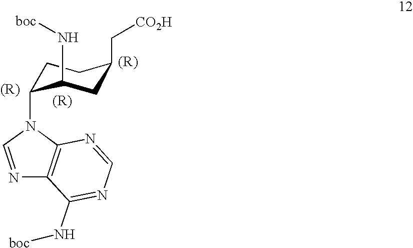

2.14 g (3.7 mmol) of N⁶-benzoyl-N⁶-tert-butoxycarbonyl-9-[(1R,5R,8R)-3-oxo-2-tert-butoxycarbonyl-2-azabicyclo[3.3.1]nonan-8-yl]adenine 13 are introduced into 80 ml of THF. At 0° C., 0.9 g (21.5 mmol) of LiOH monohydrate dissolved in 20 ml of water is added dropwise over the course of 30 min. Then 13 ml of methanol are added, and the mixture is stirred at room temperature for about 16 h. After distilling off the organic solvents in vacuo, a little water is added to the residue, the pH is adjusted to 3 with dilute HCl, and the reaction product is filtered off with suction and washed with water and acetone.

1.0 g (55.5%)

Melting point >300° C.

R_{F}=0.6 (CH₂Cl₂/CH₃OH=5:1)

[α]_{D}²²=+3.9° (c=51; CH₂Cl₂/CH₃OH=1:1)

HPLC: 98% [Cyclobond I, CH₃CN/(H₂O +0.01N TBAS)=95:5]

¹H-NMR (400 mHz, d₆-DMSO) 1.04 & 1.47 (2s, 18H, 2-tert-Bu); 1.08-1.33 (m, 2H); 1.78-2.03 (m, 4H); 2.14-2.29 (m, 3H); 4.01 & 4.31 (2m, 2H, CH—[NH] & CH—N); 6.85 (d, 1H, NH—[CH]); 8.4 & 8.54 (2s, 2H, —CH═) 9.9 (s, 1H, NH—C): 12.13 (s, 1H, CO₂H)

### EXAMPLE 14

N⁶-tert-Butoxycarbonyl-9-[(1R,2R,4R)-2-tert-butoxycarbonylamino-4-carboxymethylcyclohex-1-yl]adenine 12

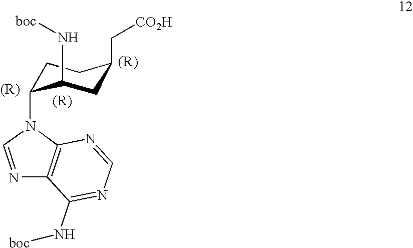

11.24 g (19.6 mmol) of N⁶-di-(tert-butoxycarbonyl)-9-[(1R,5R,8R)-3-oxo-2-tert-butoxycarbonyl-2-azabicyclo[3.3.1 ]nonan-8-yl]adenine 11 are introduced into 390 ml of THF. At −10° C., 4.11 g (98 mmol) of LiOH monohydrate dissolved in 100 ml of water are added dropwise over the course of 30 min. Then 65 ml of methanol are added and the mixture is stirred firstly at −10° C. for 2 h and then at room temperature for about 16 h. After distilling off the organic solvents in vacuo, a little water is added to the residue, the pH is adjusted to 3 with dilute HCl, and the reaction product is filtered off with suction and washed with water and acetone. 6.6 g (68.5%)

See example 13 for physical data

### EXAMPLE 15

N⁶-tert-Butoxycarbonyl-9-[(1R,2R,4R)-2-tert-butoxycarbonylamino-4-carboxymethylcyclohex-1-yl]adenine 12

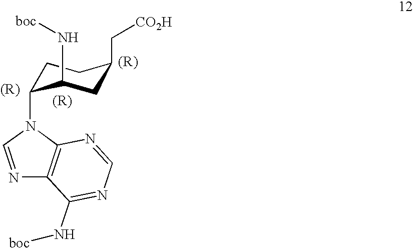

5.3 g (9.25 mmol) of N⁶-di-(tert-butoxycarbonyl)-9-[(1R,5R,8R)-3-oxo-2-tert-butoxycarbonyl-2-azabicyclo[3.3.1]nonan-8-yl]adenine 11 are introduced into 180 ml of methanol. At −15° C., 1.89 g (45 mmol) of LiOH monohydrate, dissolved in 100 ml of water, are added dropwise over the course of 30 min. The mixture is stirred at −15° C. until the starting material has disappeared and then at room temperature for about 16 h. After distilling off the organic solvents in vacuo, the aqueous residue is adjusted to pH 3 with dilute HCl, and the reaction product is extracted with methylene chloride. The product is purified by chromatography. (SiO₂: CH₂Cl₂/CH₃OH=5:1) 3.8 g (84%) 0.53 g (16%) N⁶-(tert-butoxycarbonyl)-9-[(1R,5R,8R)-3-oxo-2-azabicyclo[3.3.1 ]nonan-8-yl]adenine

See example 13 for physical data

### EXAMPLE 16

9-[(1R,2R,4R)-2-tert-Butoxycarbonylamino-4-carboxymethylcyclohex-1-yl]adenine 10

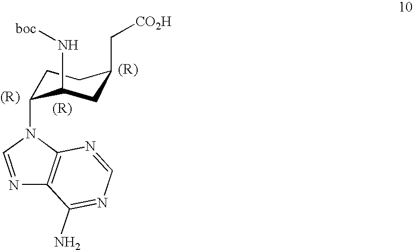

5.0 g (12 mmol) of N⁶-(dimethylaminomethylene)-9-[(1R,5R,8R)-3-oxo-2-tert-butoxycarbonyl-2-azabicyclo[3.3.1]nonan-8-yl]adenine 9 are introduced into 240 ml of methanol. At −15° C., 2.52 g (60 mmol) of LiOH monohydrate, dissolved in 60 ml of water, are added dropwise over the course of 30 min. The mixture is stirred at −15° C. until the starting material has disappeared, and then at room temperature for about 16 h. After the organic solvents have been distilled off in vacuo, the aqueous residue is adjusted to pH 3 with dilute HCl, and the reaction product is extracted with methylene chloride. The product is purified by chromatography.

(SiO₂: acetone/CH₂Cl₃/CH₃OH/EtOAc/H₂O/AcOH=9:6:2:2:2:1) 2.4 g (51.3%)

Melting point 221° C. (decomposition)

R_{F}=0.31 (CH₂Cl₂/CH₃OH=5:1)

HPLC: >98% [LiChrospher RP 18, CH₃CN/(H₂O+0.01N TBAS)=15:85] [α]_{D}²²=−19.50° (c=0.51; CH₃OH)

¹H-NMR (400 mHz, d₆-DMSO) 1.09 (s, 9H, tert-Bu); 1.05-1.31 (m, 2H); 1.76-2.01 (m, 4H); 2.08-2.26 (m, 3H); 3.98 & 4.22 (2m, 2H, CH—[NH] & CH—N); 6.79 (d, 1H, NH—CO); 7.07 (s, 2H, NH₂); 8.07 & 8.11 (2s, 2H, ═CH); 12.2 (broad s, 1H, CO₂H)

1.3 g (40%) of 9-[(1R,5R,8R)-3-oxo-2-azabicyclo[3.3.1]nonan-8-yl]adenine 7 are isolated as by-product.

(R)-Cytosine building block

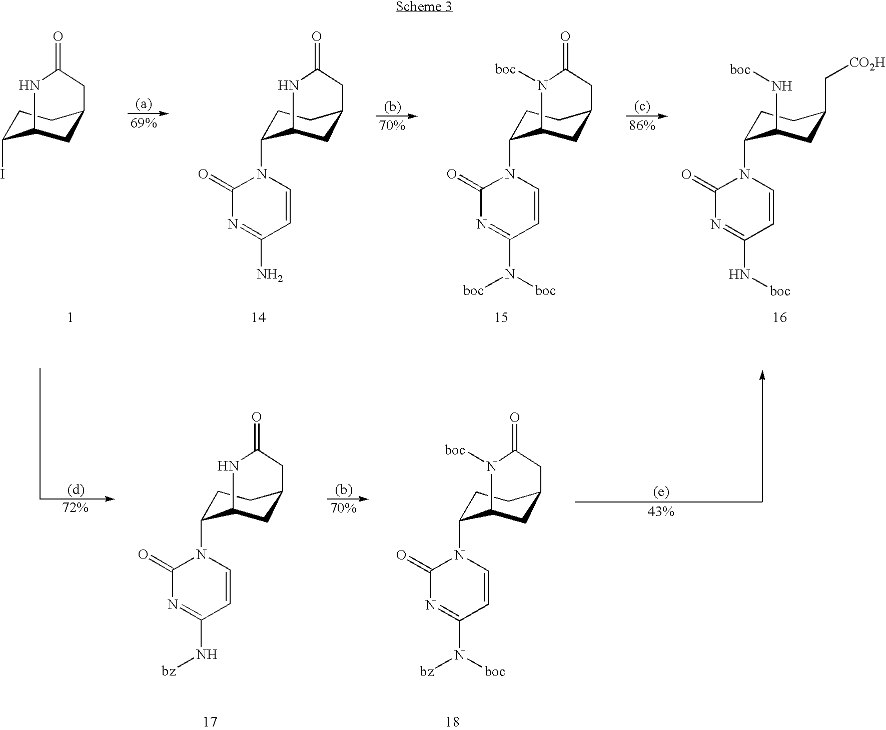

(a) cytosine, NaH, DMF, 0° C./RT-(b) (Boc)₂O, TEA, DMAP, CH₂Cl₂-(c) LiOH, CH₃OH/H₂O, −15° C./RT-(d) NaH, N⁴-benzoylcytosine, DMF, ° C./RT-(e) LiOH, THF/H₂O/CH₃OH, −10° C./RT

### EXAMPLE 17

N⁴-Benzoyl-1-[(1R,5R,8R)-3-oxo-2-azabicyclo[3.3.1]nonan-8-yl]cytosine 17

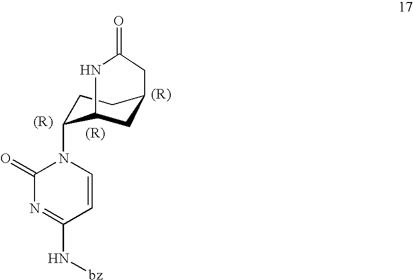

0.4 g (10 mmol) of NaH (60%) is introduced into 50 ml of DMF at 0° C., and 2.65 g (10 mmol) of (1R,5R,8R)-8-iodo-2-azabicyclo[3.3. 1]nonan-3-one 1 are added. Evolution of H₂ ceases after about 30 min, and 2.15 g (10 mmol) of N⁴-benzoylcytosine can be added. The cooling is then removed, and the mixture is stirred at room temperature overnight (about 18 h). The DMF is distilled off in vacuo, and the residue is taken up in methylene chloride and washed twice with saturated brine. The organic phase is dried and evaporated. The solid residue is purified by chromatography. (SiO₂:EtOAc/CH₃OH=5:1) 2.55 g (72%)

Melting point >300° C.

R_{F}=0.52 (CH₂Cl₂/CH₃OH=5:1)

[α]_{D}²²=+88.7° (c=0.8; CH₃OH)

HPLC: >97% [LiChrospher RP 18, CH₃CN/(H₂O+0.01N TBAS=30:70, flow 1 ml/min]

¹H-NMR (400 mHz, d₆-DMSO) 1.49-1.69 (m, 3H); 1.85-1.98 (m, 1H); 2.01-2.25 (m, 4H); 2.44-2.53 (m, 1H); 3.75 & 4.38 (2m, 2H, CH—[NH] & CH—N); 7.32-8.3 (m, 8H, Ph, N—CH═CH, NH—[CH]); 11.23 (s, 1H, NH—CO)

### EXAMPLE 18

1-[(1R,5R,8R)-3-Oxo-2-azabicyclo[3.3.1]nonan-8-yl]-cytosine 14

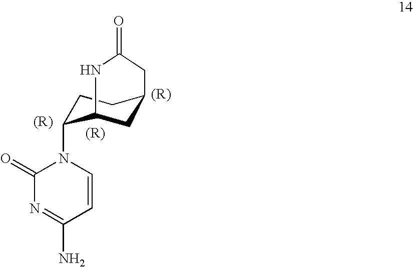

0.96 g (24 mmol) of NaH (60%) is introduced into 75 ml of DMF, and 2.22 g (20 mmol) of cytosine are added; the mixture is then stirred until evolution of H₂ has ceased. Then 5.3 g (20 mmol) of (1R,5R,8R)-8-iodo-2-azabicyclo[3.3.1]nonan-3-one 1 are added, and the mixture is stirred at room temperature for a further 15 h. The DMF is distilled off in vacuo, and the residue is mixed with 2.7 g (20 mmol) of KH₂PO₄ dissolved in 100 ml of water. The aqueous phase is firstly washed twice with ethyl acetate and then put on an XAD 16 column. The column is washed thoroughly with water and then with methanol. The product is obtained from the methanol fraction and is stirred with ethyl acetate, filtered off with suction and dried.

3.42 g (69%)

Melting point >300° C.

R_{F}=0.26 (acetone/CH₂Cl₂/CH₃OH/EtOAc/H₂O/AcOH=9:6:2:2:21)

[α]_{D}²²=+103° (c=0.4; CH₃OH)

HPLC: 98% [Cyclobond I, CH₃CN/(H₂O+0.01N TBAS)=75:25]

¹H-NMR (400 mHz, d₆-DMSO) 1.45-1.63 (m, 3H); 1.7-1.83 (m, 1H); 1.9-2.1 (m, 3H); 2.12-2.2 (m, 1H); 2.39-2.48 (m, 1H); 3.65 & 4.21 (2m, 2H, CH—[NH] & CH—N); 5.71 & 7.71 (2d, 2H, N—CH═CH); 6.80-7.15 (“m”, 2H, NH₂); 7.92 (d, 1H, NH—[CH])

### EXAMPLE 19

1-[(1R,5R,8R)-3-Oxo-2-azabicyclo[3.3.1]nonan-8-yl]cytosine 14

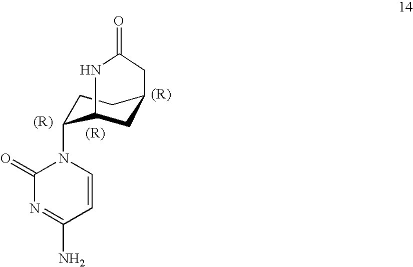

1.11 g (10 mmol) of cytosine, 2.65 g (10 mmol) of (1R,5R,8R)-8-iodo-2-azabicyclo[3.3.1]nonan-3-one 1 and 2.1 g (15 mmol) of K₂CO₃ in 50 ml of DMSO are stirred at room temperature for 2 days. The DMSO is distilled off as far as possible under good vacuum, and the residue is taken up in water and put on an XAD 16 column; the latter is firstly washed thoroughly with water, and the reaction product can subsequently be dissolved off with methanol. Final purification takes place by chromatography. (SiO₂:acetone/CH₂Cl₂/CH₃OH/EtOAc/H₂O/AcOH=9:6:2:2:2:1)

1 g (40%)

See example 18 for physical data

### EXAMPLE 20

N⁴-Benzoyl-N⁴-(tert-butoxycarbonyl)-1-[(1R,5R,8R)-3-oxo-2-tert-butoxycarbonyl-2-azabicyclo[3.3.1]nonan-8-yl]cytosine 18

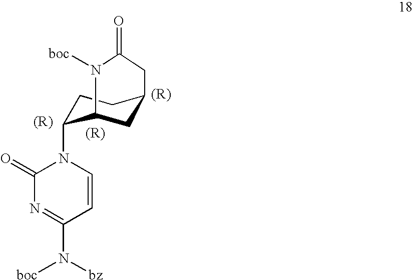

3.5 g (10 mmol) of N⁴-benzoyl-1-[(1R,5R,8R)-3-oxo-2-azabicyclo[3.3.1]nonan-8-yl]cytosine 17, 6.55 g (30 mmol) of di-tert-butyl pyrocarbonate and 250 mg of DMAP are stirred in 100 ml of acetonitrile at room temperature for 24 h. The reaction mixture is evaporated in vacuo and the residue is purified by chromatography. (SiO₂:EtOAc) 3.86 g (70%)

Melting point 181° C.

R_{F}=0.61 (EtOAc)

[α]_{D}²²=+15.3° (c=1; CH₃OH)

HPLC: 98% [Cyclobond I, CH₃CN/(H₂O+0.01 N TBAS)=98:2]

¹H-NMR (400 mHz, d₆-DMSO) 1.27 & 1.41 (2s, 18H, 2-tert-Bu); 1.45-1.54 (m, 1H); 1.72-1.82 (m, 1H); 1.83-1.97 (m, 3H); 1.99-2.12 (m, 1H); 2.2-2.36 (m, 2H); 2.65-2.75 (m, 1H); 4.37 & 4.41 (2m, 2H, CH—[NH] & CH—N); 6.97 & 8.31 (2d, 2H, N—CH═CH); 7.55-7.88 (m, 5H, Ph)

### EXAMPLE 21

N⁴-di-(tert-Butoxycarbonyl)-1-[(1R,5R,8R)-3-oxo-2-tert-butoxycarbonyl-2-azabicyclo[3.3.1]nonan-8-yl]cytosine 15

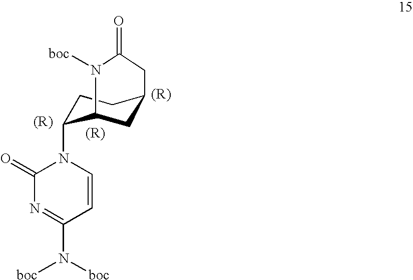

9.0 g (36.2 mmol) of 1-[(1R,5R,8R)-3-oxo-2-azabicyclo[3.3.1]nonan-8-yl]cytosine 14, 5 ml (36.5 mmol) of TEA, 31.6 g (145 mmol) of di-tert-butyl pyrocarbonate and 200 mg of DMAP in 300 ml of methylene chloride are boiled under reflux for about 4 h. (TLC check: acetone/CH₂Cl₂/CH₃OH/EtOAc/H₂O/AcOH=9:6:2:2:2:1) The residue after evaporation is stirred with about 50 ml of EtOAc, cooled and filtered off with suction. (9.8 g) A further 4.1 g can be isolated from the mother liquor by chromatography. (SiO₂: EtOAc) 13.9g(70%)

Melting point 208° C.

R_{F}=0.62 (ErOAc)

[α]_{D}²²=+16.1° (c=0.99; CH₂Cl₂)

HPLC: >98% [LiChrospher RP 18, CH₃CN/(H₂O+0.01N TBAS=60:40, flow 1 ml/min]

¹H-NMR (400 mHz, CDCl₃) 1.53 & 1.56 (2s, 27H, 3-tert-Bu); 1.53-1.56 (m, 1H); 1.78-1.88 (m, 1H); 1.96-2.2 (m, 4H); 2.31-2.48 (m, 2H); 2.68-2.79 (m, 1H); 4.35 & 4.63 (2m, 2H, CH-[NH] & CH-N); 7.03 & 7.72 (2d, 2H, N—CH═CH)

### EXAMPLE 22

N⁴-tert-Butoxycarbonyl-1-[(1R,2R,4R)-2-tert-butoxycarbonylamino-4-carboxymethylcyclohex-1-yl]cytosine 16

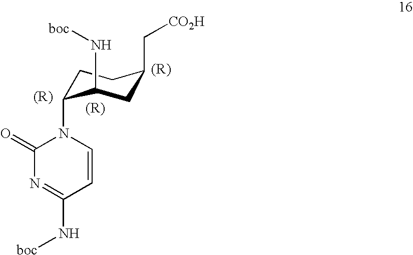

5 g (9 mmol) of N⁴-benzoyl-N⁴-(tert-butoxycarbonyl)-1-[(1R,5R,8R)-3-oxo-2-tert-butoxycarbonyl-2-azabicyclo[3.3.1]nonan-8-yl]cytosine are introduced into 180 ml of THF. At −10° C., 1.9 g (45 mmol) of LIOH monohydrate in 45 ml of water are added dropwise over the course of 30 min. Addition of 30 ml of methanol is followed by stirring at −10° C. for 2 h and at room temperature for about 18 h. The organic solvents are distilled off in vacuo, and the aqueous phase is adjusted to pH 3 with dilute HCl and extracted with methylene chloride. The latter is dried and evaporated, and the residue is purified by chromatography. (SiO₂: CH₂Cl₂/CH₃OH=95.5) 1.8 g (43%)

Melting point >300° C.

R_{F}=0.7 (CH₂Cl₂/CH₃OH=5:1)

[α]_{D}²²=+29.6° (c=0.54 CH₃OH)

HPLC: 98% [Cyclobond I, CH₃CN/(H₂O+0.01N TBAS)=90:10]

¹H-NMR (400 mHz, d₆-DMSO) 1.05 & 1.25 (2s, 18H, 2-tert-Bu); 1.0-1.14 (m, 1H); 1.4-1.78 (m, 6H); 1.9-2.05 (m, 2H); 3.6 & 4.22 (2m, 2H, CH—[NH]CH—N); 6.62 (d, 1H, NH—[CH]); 6.7 & 7.89 (2s, 2H, N—CH═CH) 9.5-12.5 (2H, NH—C, CO₂H)

(R)-Guanine Building Block

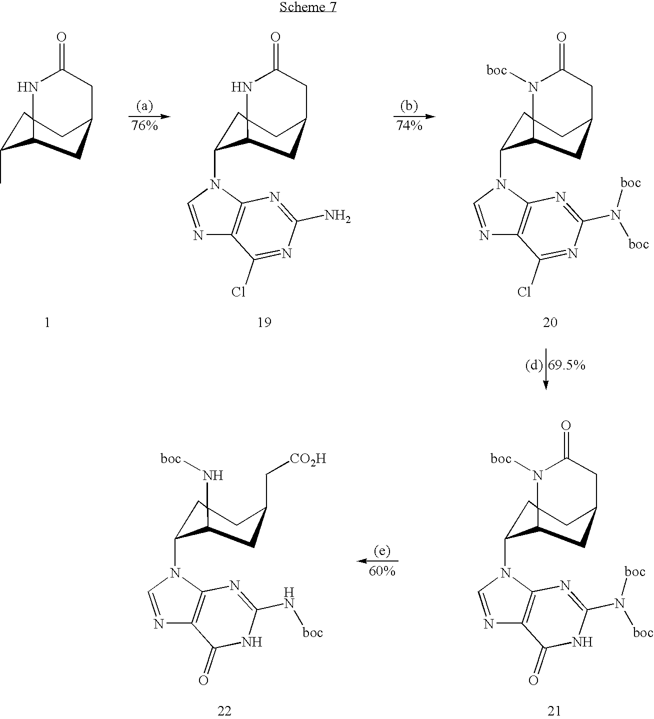

(a) 6-chloro-2-amino-purine, NaH DMF, 0° C./RT-(b) (Boc)₂O, TEA, DMAP, CH₂Cl₂-(c) (CH₃)₃N, 3-HO-propionitrile, DBU, CH₂Cl₂, 0° C. then RT subsequently LiOH, CH₃OH/H₂O, −15° C./RT-(d) (CH₃)₃N, 3-HO-propionitrile, DBU, CH₂Cl₂, 0° C. then RT-(e) LiOH, THF/H₂O/CH₃OH, 0° C./RT

### EXAMPLE 23

2-Amino-6-chloro-9-[(1R,5R,8R)-3-oxo-2-azabicyclo[3.3.1]nonan-8-yl]purine 19

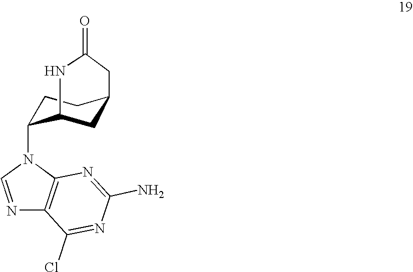

2 g (50 mmol) of NaH (60%) are introduced into 150 ml of DMF. At 0° C., 13.25 g (50 mmol) of (1R,5R,8R)-8-iodo-2-azabicyclo[3.3.1 ]nonan-3-one 1 are added in portions in a short time; evolution of H₂ has ceased after about 30 min at 0° C., and 8.5 g (50 mmol) of 2-amino-6-chloropurine are added. The reaction mixture is then stirred at room temperature for 24 h. After the DMF has been distilled off in vacuo, the solid residue is made into a paste with about 70 ml of water, filtered off with suction and washed with acetone: 7.8 g of pure reaction product; a further 3.9 g of product can be isolated from the filtrate by chromatography (SiO₂: CH₂Cl₂/CH₃OH=9:1).

11.7 g (76%)

Melting point 275° C.

R_{F}=0.55 (CH₂Cl₂/CH₃OH=5:1)

HPLC: 98% [Cyclobond I, CH₃CN/(H₂O+0.01N TBAS)=92.5:7.5]

[α]_{D}²²=−10.8° (c=1; CH₃OH)

¹H-NMR (400 mHz, d6-DMSO) 1.57-1.73 (m, 3H); 1.92-2.28 (m, 5H); 2.47-2.56 (m, 1H); 4.24 (m, 1H, HC—[NH]); 4.39 (m, 1H, CH—N); 6.82 (s, 2H, NH₂); 7.92 (d, 1H, NH—CO); 8.36 (s, 1H, —CH═)

### EXAMPLE 24

2-Amino-6-chloro-9-[(1R,5R,8R)-3-oxo-2-azabicyclo[3.3.1]nonan-8-yl]purine 19

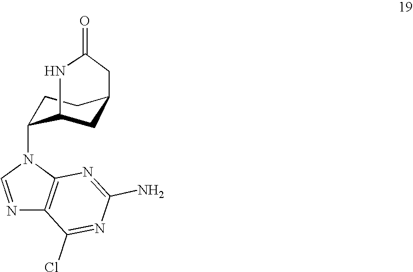

2.65 g (10 mmol) of (1R,5R,8R)-8-iodo-2-azabicyclo[3.3.1]nonan-3-one 1, 1.7 g (10 mmol) of 2-amino-6-chloropurine and 2.1 g (15 mmol) of K₂CO₃ are stirred in 50 ml of DMSO at room temperature for 24 h. After the DMSO has been distilled off in vacuo, the residue is made into a paste with 50 ml of water, filtered off with suction and washed with acetone; 1.8 g of pure product are obtained, and a further 0.3 g is isolated from the filtrate by chromatography (SiO₂: CH₂Cl₂/CH₃OH=9:1)

2.1 g (69%)

See example 28 for physical data

### EXAMPLE 25

2-[Di-(tert-butylcarbonyl)amino]-6-chloro-9-[(1R,5R,8R)-3-oxo-2-tert-butoxycarbonyl-2-azabicyclo[3.3.1]nonan-8-yl]purine 20

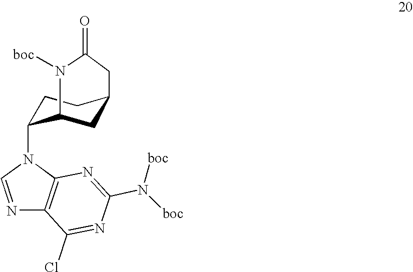

12.73 g (41.5 mmol) of 2-amino-6-chloro-9-[(1R,5R,8R)-3-oxo-2-azabicyclo[3.3.1]nonan-8-yl]purine 19, 5.75 ml (41.5 mmol) of TEA, 31.7 g (145 mmol) of di-tert-butyl pyrocarbonate and 150 mg of DMAP in 250 ml of methylene chloride are boiled under reflux for about 12 h. (TLC check: (CH₂Cl₂/CH₃OH=5:1) For workup, the solvent is distilled off and the residue is purified by chromatography. (SiO₂: EtOAc)

18.6 g (74%)

R_{F}=0.74 (EtOAc)

HPLC: >98% [LiChrospher RP 18, CH₃CN/(H₂O+0.01N TBAS)=90:10]

[α]_{D}²²=−62° (c=1.1; CH₃OH)

¹H-NMR (400 mHz, d₆-DMSO) 1.36 & 1.48 (2s, 27H, 3-tert-Bu); 1.60-1.85 (m, 3H); 2.02-2.13 (m, 2H); 2.17-2.27 (m, 1H); 2.35-2.49 (m, 2H); 2.77-2.89 (m, 1H); 4.85 (m, 1H, HC-[NH]); 5.21 (m, 1H, CH-N); 8.99 (s, 1H, —CH═)

### EXAMPLE 26

N²-tert-Butoxycarbonyl-9-[(1R,2R,4R)-2-tert-butoxycarbonylamino-4-carboxymethylcyclohex-1-yl]guanine 22

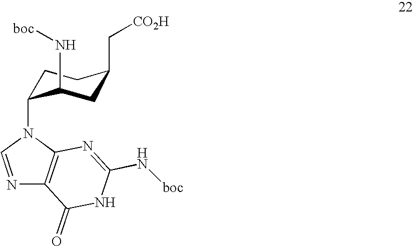

4.1 g (6.75 mmol) of 2-[di-(tert-butylcarbonyl)amino]-6-chloro-9-[(1R,5R8R)-3-oxo-2-azabicyclo[3.3.1]nonan-8-yl]purine 20 are introduced into 30 ml of methylene chloride at 0° C. Then 2.3 g (32.5 mmol) of 3-hydroxypropionitrile, 3.84 g (65 mmol) of trimethylamine and 1.5 g (9.25 mmol) of DBU are added, and the mixture is stirred at room temperature for 16 h. The residue after all the volatile constituents have been distilled off in vacuo is acidified with aqueous KH₂PO₄ solution and extracted several times with methylene chloride. Drying and evaporation of the organic phase result in a solid residue (4.26 g) which is dissolved in 145 ml of methanol and to which, at −15° C., a solution of 1.52 g (36.2 mmol) of LiOH monohydrate in 36 ml of water is added over the course of 30 min. The mixture is then stirred at −10° C. for 2 h and at room temperature for 20 h. For workup, the methanol is distilled off in vacuo, and the aqueous residue is diluted with a little water and then adjusted to pH 3 with dilute hydrochloric acid and extracted with methylene chloride. The reaction product is purified by chromatography.

(SiO₂: acetone/CH₂Cl₂/CH₃OH/EtOAc/H₂O/AcOH=9:6:2:2:2:1)

2.87 g (84%)

Melting point >300° C. (decomposition)

RF=0.79 (acetone/CH₂Cl₂/CH₃OH/EtOAc/H₂O/AcOH=9:6:2:2:2:1)

RF=0.37 (CH₂Cl₂/CH₃OH=5:1)

HPLC: >98% [Cyclobond I, CH₃CN/(H₂O+0.01N TBAS)=90:10]

[α]_{D}²²=+3.41° (c=1; CH₃OH)

¹H-NMR (400 mHz, d6-DMSO) 1.18 & 1.48 (2s, 18H, 2-tert-Bu); 1.1-1.22 (m, 1H); 1.74-1.84 (m, 1H); 1.85-1.98 (m, 4H); 2.10-2.25 (m, 3H); 3.87-4.13 (m, 2H, CH—[NH], CH—N); 6.78 (d, 1H, NH—C[H]); 7.79 (s, 1H, N—CH═N);

11.02,11.28 & 12.1 (3s, 3H, NH, NH, CO₂H)

### EXAMPLE 27

N²-di-(tert-butylcarbonyl)-9-[(1R,5R,8R)-3-oxo-2-tert-butoxycarbonylamino-2-azabicyclo[3.3.1]nonan-8-yl]guanine 21

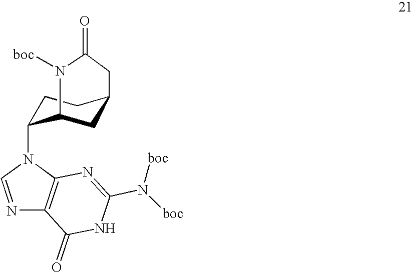

37.8 g (62.3 mmol) of 2-[di-(tert-butylcarbonyl)amino]-6-chloro-9-[(1R,5R,8R)-3-oxo-2-tert-butoxycarbonyl-2-azabicyclo[3.3.1]nonan-8-yl]purine 20 are introduced into 190 ml of methylene chloride. At 0° C., 21.4 ml (313 mmol) of 3-hydroxypropionitrile, 62.3 ml (approx. 660 mmol) of trimethylamine and 9.13 ml (59 mmol) of DBU are added, and the mixture is then stirred at room temperature for 15 h. All the volatile constituents are then distilled off in vacuo, and the residue is mixed with 300 ml of aqueous KH₂PO₄ solution and extracted with methylene chloride. Drying and evaporation of the organic phase results in a solid residue which is treated with diisopropyl ether and filtered off with suction. (approx. 27.2 g) Purification takes place by chromatography. (SiO₂: EtOAc/CH₃OH=10:1)

25.5 g (69.5%)

RF=0.28 (EtOAc/CH₃OH=5:1)

### EXAMPLE 28

Solid-phase synthesis of (R,R,R)-enantiomeric or (S,S,S)-enantiomeric CNA Oligomers

28.1 solid-phase synthesis of the CNA oligomer (R)-CNA[H(AATAT)OH] 28.1.1 loading of the support with C-terminal monomers 5 or 10.

Tentagel S HMB resin (100 mg; 28 μmol; capacity=0.28 mmol/g) is put in a 2 ml syringe and swollen with anhydrous DMF (1.5 ml) at room temperature for 5 min and then the solvent is removed. The monomer 5 (32 mg, 84 μmol) is suspended in anhydrous DMF (200 μl), and 200 μl of a solution of HATU (32 mg, 84 μmol) in anhydrous DMF and DIPEA (36 mg, 280 μmol) are added. Shaking gently for 5 minutes results in a pale yellow solution. The suspension resulting after addition of the solution to the resin is shaken at room temperature for 8 h. The reaction solution is then removed and the resin is washed with DMF (6×1.5 ml) and CH₂Cl₂ (6×1.5 ml) and dried in vacuo.

The described reaction cycle is repeated using the same stoichiometric amounts of reactants and carrying out the incubation of the solid phase with monomers 5 or 10 at room temperature overnight. After the reaction is complete, the excess reactants are removed. The resulting resin adduct is washed with DMF (6×1.5 ml), CH₂Cl₂ (6×1.5 ml) and diethyl ether (3×1.5 ml) and then thoroughly dried in vacuo.

After a sample of the monomers attached to the resin support has been cleaved off, HPLC analysis (method A) provides a loading of 0.11-0.14 mmol/g. For quantitative determination of the loading of the resin with the respective monomers, a defined amount (approx. 3-4 mg) of the resin (mᵣₑₛᵢₙ) is treated with 2N NaOH (150 μl) at room temperature for 30 min. The resin is then filtered off and washed twice with the same amount of 2N NaOH (150 μl). The filtrates are combined and made up to a volume of 1 ml with 2N NaOH. A 100 μl sample of this is taken from this solution and diluted to 1 ml with 2N NaOH for the spectrometric investigation of the filtrate. The extinction E of the filtrate diluted in this way is determined at 273 nm when CNA thymine derivatives are present (E_{273 nm}=11500 |·mol⁻¹·cm⁻¹), or at 260 nm when CNA adenine derivatives are present (E₂₆₀ₙₘ =15400 |·mol⁻¹·cm⁻¹). The capacity X [mmol/g] of the resin can be calculated therefrom with the aid of the values obtained according to the following formula:

X=V×E/(ε×d×mᵣₑₛᵢₙ)

To cap free hydroxyl groups, the resin is suspended in CH₂Cl₂ (700 μl) and treated with Ac₂O (206.7 mg; 2.0 mmol) and DIPEA (256.7 mg; 2.0 mmol) at room temperature for 15 min if the adenine monomer is present, or 1 h if a thymine monomer is present. Excess reactants are then removed and the resin is washed with CH₂Cl₂ (10×1.5 ml) and then thoroughly dried.

28.1.2 Preactivation of Monomers 5 and 10

HATU (42 μmol) (Perspeptive Biosystems) is added to a solution of monomers 5 or 10 (42 μmol) in anhydrous DMF (150 μl). The mixture is then shaken for 1 min. Incubation of the resulting suspension with DIEA (10.9 mg, 84 μmol) at room temperature for five minutes results in a pale yellow solution. The monomer activated in this way can now be employed for the solid-phase reaction (oligomerization).

28.1.3 Check of Coupling Efficiency

The efficiency of the coupling reaction is checked by means of RP-HPLC (method C). For this purpose, a sample of the resin (approx. 1 mg) is taken from the reaction mixture and treated with 2N NaOH/MeOH (90 μl, 1:1) for 5-10 min. The sample solution is then neutralized with 2N HCl (90 μl) and analyzed by RP-HPLC.

28.1.4 Synthesis Protocol (See Table 1):

100 mg of the resin (14 μmol; capacity: 0.14 mmol/g), loaded with monomers 5 or 10, are put in a syringe (2 ml). The N-terminal Boc protective group is eliminated with TFA-CH₂Cl₂ 1:1 (1.5 ml), method step 1) at room temperature for 5 min. The reaction solution is removed and fresh deprotection reagent [TFA-CH₂Cl₂ 1:1 (1.5 ml)] is added anew and incubated at RT for a further 30 min. The resin is washed with CH₂Cl₂ (2×1.5 ml), neutralized with 1M DIEA in DMF (4×1.5 ml) and then washed anew with DMF (6×1.5 ml) and with CH₂Cl₂ (6×1.5 ml) (method steps 2 to 4, table 1). The Boc-deprotected resin is dried in vacuo and then treated with anhydrous DMF (1.5 ml) for 5 min. After removal of the DMF, the solution of the activated monomer 5 or 10 (42 μmol) (see 1.1.2) is added. The suspension is shaken for 4 h (method step 5, table 1). After completion of the coupling, the supernatant is filtered off and the resin is washed with DMF (6×1.5 ml) and with CH₂Cl₂ (6×1.5 ml) (method step 6, table 1). A 10 sample of the resin-bound coupling product is taken for HPLC analysis (see above, method C). Since the coupling proceeds quantitatively, subsequent capping of free terminal amino functions is unnecessary.

28.1.5 Elimination of the N-terminally Substituted Oligomers from the Support

After completion of the oligomerization, the product is eliminated from the support by treating the resin-bound oligomer with 2 ml of a 2M aqueous NaOH solution in MeOH (1:1) at room temperature for two hours. After neutralization of the solution with 2M HCl, the resulting oligomer can be purified by RP-HPLC (method D). The product-containing fractions are combined and concentrated by lyophilization.

ESI-MS: (R)-CNA[H(AATAT)OH] (1360.7 [M+H]⁺, M_{calc.}=1360.7 RP-HPLC (Method C): (R)-CNA[H(AATAT)OH] (Rₜ=15.0 min). Tm value =27.4°.

All CNA oligomers synthesized by this method are listed in table 2 below.

TABLE 2
Characterization of the CNAs by RP-HPLC and ESI-MS

| | Analytical HPLC | | |
|---|---|---|---|
| | Reverse phase | ESI-MS | |
| Base sequence | t_{R} [min] | M_{(obs)}^{d)} | M_{(calc)} |
| (S)-AATAT^{b)} | 15.0 | 1360.7 | 1360.7 |
| (R)-AATAT^{b)} | 15.0 | 1360.5 | 1360.7 |
| (S)-(phba)-AATAT^{c)} | 22.9 | 1526.7 | 1526.6 |
| (R)-(phba)-AATAT^{c)} | 22.9 | 1527.0 | 1526.6 |
| Conjugate 1 | 16.9 | 2227.6 | 2227.4 |
| Conjugate 2 | 16.7 | 1935.9 | 1935.2 |
| (S)-AAATT^{b)} | 14.6 | 1361.0 | 1360.7 |
| (S)-(phba)-AAATT^{c)} | 20.5 | 1527.0 | 1526.6 |
| (S)-AATTT^{b)} | 13.2 | 1351.5 | 1351.5 |
| (S)-(phba)-AATTT^{c)} | 21.6 | 1518.0 | 1518.3 |
| (R)-TTAAA^{b)} | 13.1 | 1360.7 | 1360.7 |
| (R)-(phba)-TTAAA^{c)} | 18.5 | 1527.0 | 1526.6 |
| (S)-ATATA^{b)} | 15.5 | 1360.6 | 1360.7 |
| (S)-(phba)-ATATA^{c)} | 15.1 | 1527.0 | 1526.6 |
| (R)—(Ac)-CTGAA(Lys)^{c)} | 13.4 | 1532.8 | 1532.8 |
| (R)—(Ac)-CTGAA(Lys-Cy5)^{c)} | 32.8 | 2173.2 | 2173.6 |
| (R)—(Ac)-CCTGAA(Lys)^{c)} | 15.4 | 1781.9 | 1781.0 |
| (R)—(Ac)-TCCTGAA(Lys)^{c)} | 16.9 | 2044.2 | 2044.3 |
| (R)-(phba)-ATATT^{a)} | 20.8 | 1518.0 | 1518.5 |

^{a)}(R)—(X)ₙ and (S)—(X)ₙ stand for (1′R,2′R,4′R)-CNA-[H(X)ₙOH], (1′S,2′S,4′S)-CNA-[H(X)ₙOH], X: are in this connection the monomer building blocks T, C, G and A, phba: (HO)₂P(═O)—O—(CH₂)₃—C(═O) radical, Lys: lysine residue, Ac: acetyl radical.
^{b)}Method B: Merck LiChrospher, 5 μm, 250 × 4.0 mm; elution with water (0.1% TFA) and a linear gradient of MeCN [(0.1% TFA), 10-40% within 30 min].
^{c)}Method C: Merck LiChrospher, 5 μm, 250 × 4.0 mm; elution with water (0.1% TFA) and a linear gradient of MeCN [(0.1% TFA), 10-30% within 40 min].
^{d)}The observed relative molecular weight was obtained starting from the singly positively charged molecule ion of the respective CNA oligomer.

28.1.6 CNA/p-RNA Hybridization

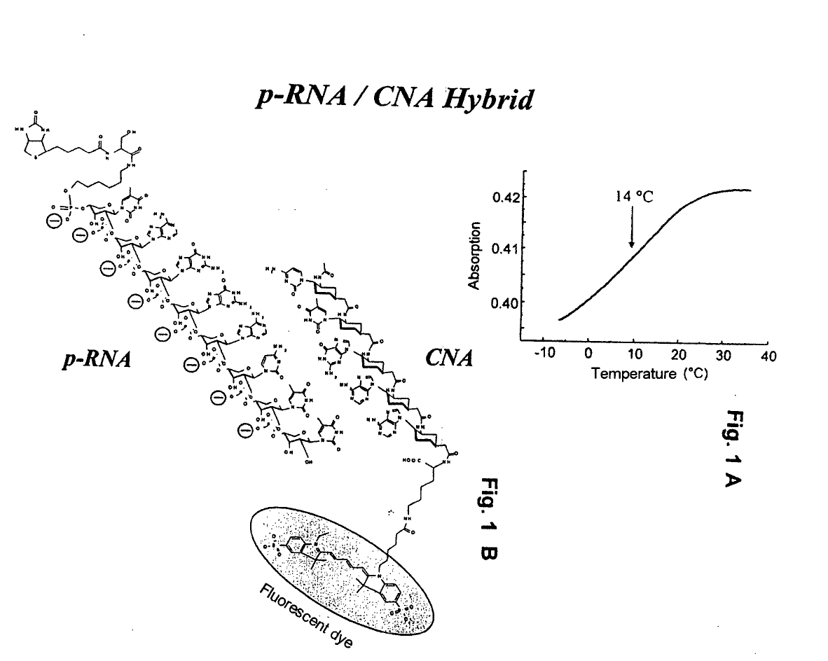

The oligonucleotide strands of the CNA and p-RNA were dissolved in 5 mM Tris HCl buffer so that a CNA concentration of 5 μm and an equimolar p-RNA concentration of 5 μm was present. The solution was then investigated by absorption spectroscopy at a wavelength of 265 nm in the temperature range from 35° C. to −8° C. (ramp rate 80 s/° C.). The absorption values were recorded with a Perkin Elmer apparatus (Lambda 2). FIG. 1A shows that there is stable pairing even with the short 5-mer heteroduplex (FIG. 1B). The melting point is 14° C. In addition, this example shows that the pairing takes place even under low-salt conditions.

### EXAMPLE 29

Improvement of the Solubility of CNAs by Introducing a Butyrophosphate Group.

29.1 Addition of di(p-methoxyphenyl)phenylmethyl-protected 4-hydroxybutanoic acid onto the N terminus of the resin-bound pentamer (R)-CNA[H(AATAT)OH].

A solution of 4-(4,4-dimethoxytrityloxy)butanoic acid (57 mg, 140 μmol) [14] and HATU (53 mg, 140 μmol) in DMF (400 μl) is stirred for 10 min before addition of DIEA (27 mg, 210 μmol) and, after a further 2 min, the solution is added to 100 mg of the Tentagel S HMB resin support (0.14 mmol/g, 0.014 mmol) loaded with the pentamer residue (R)-CNA[H(AATAT)OH]. The resin is then treated in analogy to method steps 1-4 (table 1). Finally, the supernatant is filtered off, and the modified resin is washed with DMF (4×4 ml) and CH₂Cl₂ (2×4 ml).

29.2 Detritylation

For the detritylation, the modified resin is treated with a 6% strength solution of dichloroacetic acid in CH₂Cl₂ five times each for 2 min, washed with CH₂Cl₂ (4×4 ml) and with MeCN (4×4 ml) and finally dried over P₂O₅ under high vacuum overnight.

29.3 Phosphorylation and Oxidation:

The dried modified resin is swollen with 2 ml of a 0.5M solution of pyridinium hydrochloride in anhydrous MeCN for 10 min. The reaction vessel is subsequently put under Ar atmosphere, and a solution of 0.5M pyridinium hydrochloride in MeCN (780 μl) and MeCN (145 μl) are added. Then a solution of bis(2-cyanoethyl)-N,N-diisopropylaminophosphoramidite in anhydrous MeCN (75 μl, 300 mM) is pipetted onto the modified resin and shaken for 45 min. After removal of the supernatant, fresh phosphorylation reagent is added again to the resin and treated for 45 min. The described reaction cycle is carried out a total of four times. The resin is then freed of the supernatant and washed with MeCN (6×1 ml) and then treated 3× with 1.5 ml of an iodine-containing oxidation solution composed of 5 mmol of iodine, 223 mmol of collidine in MeCN/H₂O (64:36) for 2 min. After oxidation is complete, the phosphorylated oligomer is washed 5× with 1.5 ml of a 0.5M solution of pyridinium hydrochloride in anhydrous MeCN and 5× with 1.5 ml of MeCN.

29.4 Elimination of the Cyanoethyl Groups

The loaded resin is treated with 1.5 ml of a 2.7M solution of DBU in MeCN at room temperature for 15 h and then washed with MeCN (6×1.5 ml) and with CH₂Cl₂ (6×1.5 ml).

29.5 Elimination of the N-terminally Substituted Oligomer from the Support

After completion of the synthesis, the phosphorylated product is eliminated from the support by treatment with 2 ml of a 2M aqueous NaOH solution in MeOH (1:1) at room temperature for two hours. After neutralization with 2M HCl, the phosphorylated crude oligomer product is purified by RP-HPLC (method D). The resulting oligomer fractions are combined and concentrated by lyophilization.

ESI-MS: (R)-CNA[phba(AATAT)OH](1527.0 [M+H]⁺, 764.5 [M+H]²⁺; M_{calc.}=1526.6 RP-HPLC (Method C): (R)-CNA[phba(AATAT)OH] (Rₜ=22.9 min).

Tm value=33.6°.

### EXAMPLE 30

Improvement of the Solubility of CNAs by Direct Introduction of 4-[(bis(phenylmethoxy)phosphinyl]oxy]butanoic Acid

30.1 Synthesis of Methyl 4-hydroxybutanoate

Butyrolactone (12 g, 140 mmol), MeOH (130 ml) and conc. sulfuric acid (8 drops) are heated together under reflux for 8 h. The mixture is allowed to cool to RT and, while cooling in ice/salt, NaHCO₃ (1 g) is added, and the mixture is stirred for a further 10 min. The solid residue is filtered off and the solvent is removed in a rotary evaporator. The resulting colorless liquid is purified by chromatography on silica gel (14×5.5 cm, Et₂O/CH₂Cl₂ 3:2). The pure ester fractions are combined and result, after removal of the solvent, in 1.5 g (12.7 mmol, 9%) of the ester.

30.2 Synthesis of Methyl 4-[[bis(phenylmethoxy)phosphinyl]oxy]butanoate

6.9 g (19.7 mmol) of tribenzyl phosphite are dissolved in abs. CH₂Cl₂ (70 ml) and, at 0° C., iodine (4.59 g, 18 mmol) is added in portions. The iodine dissolves within 30 min to result in a clear colorless solution. HBU methyl ester (1.94 g, 16.4 mmol) are dissolved in abs. CH₂Cl₂ (150 ml) and cooled with an ice/salt mixture to −10° C., and pyridine (5.3 ml=5.18 g, 65.7 mmol) is added. The solution of phosphorylation reagent is then added dropwise over the course of 30 min and stirred for a further 10 min. Addition of 20% strength citric acid (3×80 ml) is followed by extraction and twice with water (80 ml) dried over Na₂SO₄. Chromatography on silica gel (11.5×5.5 cm, 400 ml of CH₂Cl₂, 200 ml each of CH₂Cl₂/MeOH 20:1 and 15:1 then with 10:1 until the product elutes) affords the desired product (4.75 g, 12.1 mmol, 74%).

30.3 Synthesis of 4-[[bis(phenylmethoxy)phosphinyl]oxy]butanoic Acid

Methyl 4-[[bis(phenylmethoxy)phosphinyl]oxy]butanoate (2 g, 5.3 mmol) is dissolved in MeOH (150 ml) and mixed with 1M NaOH (15 ml), and the mixture is stirred at RT for 6 h. The reaction volume is concentrated to one half in a rotary evaporator at RT, 1M NaOH (60 ml) is added, and the solution is extracted three times with Et₂O. The aqueous phase is isolated, acidified (pH 1-2) with conc. HCl and extracted three times with ethyl acetate. The combined organic phases are dried over Na₂SO₄, and the resulting milky suspension is purified on silica gel (8×5.5 cm, CH₂Cl₂/MeOH 8:1). 1.2 g of the desired product are obtained (3.3 mmol, 62%).

30.4 Synthesis of (R)-CNA[phba(ATATT)OH]

65 mg (6 μmol) of the support charged with (R)-CNA[H(ATATT)OH] oligomer are introduced into a syringe (2 ml). The N-terminal Boc protective group is removed by the action of TFA-CH₂Cl₂ 1:1 (1.5 ml) for 5 min. Fresh deprotection reagent is added and the Boc deprotection reaction is carried out for a further 30 min at RT. The reaction solution is removed, the support is washed with CH₂Cl₂ (2×1.5 ml), neutralized with 1M DIPEA in DMF (4×1.5 ml) and washed with DMF (6×1.5 ml) and CH₂Cl₂ (6×1.5 ml) (operations 2-4). The Boc-deprotected support is then swollen with abs. DMF (1.5 ml) for 5 min, and the solvent is filtered off. 4-[[Bis(phenylmethoxy)phosphinyl]oxy]butanoic acid (6.6 mg, 18 μmol) are dissolved in abs. DMF (250 μl), HATU (6.9 mg, 18 μmol) is added and DIPEA (6.3 μl, 36 μmol) is pipetted in. After about 2 min, a clear pale yellow-colored solution is obtained and is added to the Boc-deprotected carrier. The coupling is carried out at RT for 4 h. After elimination of the benzyl protective group with TFA-H₂O-triethylsilane (2 ml; 95:2,5:2.5), the phosphorylated pentamer results in almost quantitative yield.

### EXAMPLE 31

C-terminal Peptide Conjugation of a CNA Oligonucleotide in Solution.

31.1 Lodoacetylation of (S)-CNA[Ac(AATAT)-Lys-OH] at the ε-amino Function of Lysine

690 nmol of (S)-CNA[Ac(AATAT)-Lys-OH] are dissolved in 800 μl of 0.1M sodium bicarbonate/DMF (1:2) and shaken with 150 equivalents of N-succinimidyl iodoacetate (102 μmol, 28.9 mg) with exclusion of light for 2 h. The product (S)-CNA[Ac(AATAT)-Lys(N^{ε}-iodoacetyl)-OH] is purified directly by preparative RP-HPLC and desalted on an RP-C18 cartridge. A solvent mixture which can be used for sparingly soluble oligonucleotides is DMSO with 3 equivalents of pyridine based on the oligonucleotide employed.

31.2 Conjugation of (S)-CNA[Ac(AATAT)-Lys(N^{ε}-iodoacetyl)-OH] with H-Cys-Ser-Lys-Val-Gly-OH (Conjugate 1).

106 nmol of (S)-CNA[Ac(AATAT)-Lys(N^{ε}-iodoacetyl)-OH] are dissolved in 20 μl of DMF and then a solution of H-Cys-Ser-Lys-Val-Gly-OH (256 nmol, 162 μg) in 20 μl of DMF/EDTA-borax-HCl buffer (pH=7.5) is added. The mixture is shaken with exclusion of light for 2 h until the oligonucleotide has completely reacted. The CNA conjugate (conjugate 1) is then purified directly by RP-HPLC and desalted on an RP-C18 cartridge.

### EXAMPLE 32

N-terminal Peptide Conjugation of Resin-bound CNA Oligonucleotides (Conjugate 2)

(S)-CNA[Lys(TTTTT)OH] (200 nmol based on the oligonucleotide, loading 0.11 mmol/g, 2 mg of resin) linked C-terminally to the resin are mixed with 300 μl of a 0.1M sodium bicarbonate/DMF (1:2) solution and 150 equivalents of N-succinimidyl iodoacetate (30 μmol, 8.5 mg) and shaken with exclusion of light for 2 h. The resin beads are then filtered and washed with DMF. The resulting iodoacetyl derivative (S)-CNA[(N^{ε}-iodoacetyl)-Lys(TTTTT)-resin] is then reacted with 400 nmol of H-Cys-Ala-Ala-Ala-Gly-NH₂ in 200 μl of DMF/EDTA-borax-HCl buffer (pH=7.5) (2:1). After washing with DMF and dichloromethane, the product can be eliminated from the resin with 2M NaOH. After neutralization of the NaOH solution with 1M HCl, the crude product is purified directly by RP-HPLC and desalted on an RP-C18 cartridge.

### EXAMPLE 33

Fluorescence Labeling of a CNA Oligonucleotide in Solution

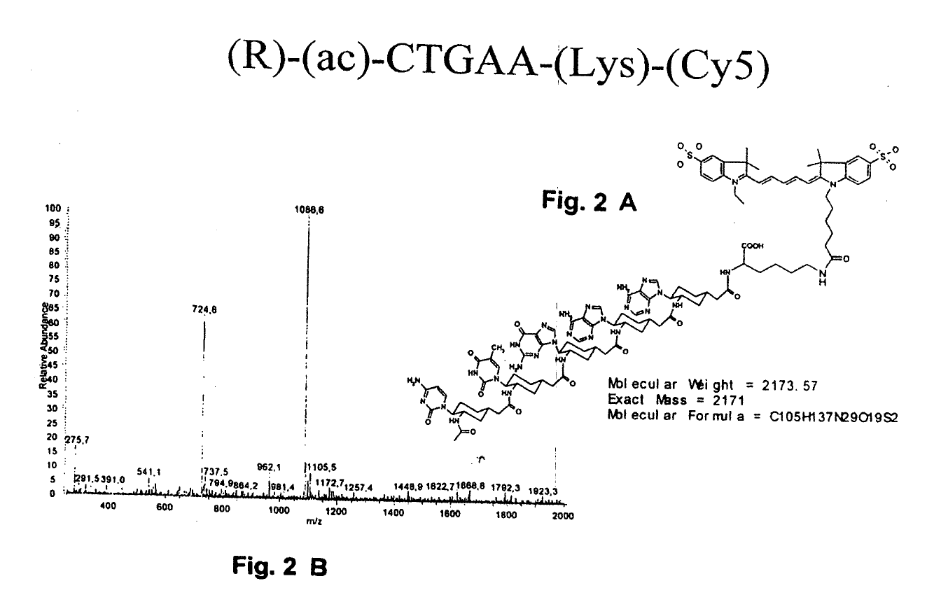

A solution of 50 μl of DMF and 780 nmol of DIPEA is added to a solution of 130 nmol of (R)-CNA[Ac-(CTGAA)-Lys] in 50 μl of DMF. The combined solution is then reacted with a Cy5 labeling kit (approx. 150 nmol) (Amersham Pharmacia Biotech, Prod. No.: PA15001). The reaction mixture is shaken with exclusion of light for 24 h until the oligonucleotide has completely reacted. The labeled oligonucleotide can be purified directly by RP-HPLC and desalted on an RP-C18 cartridge. The resulting compound is depicted together with the relevant mass spectrum in FIG. 2A and B.

1. A method for the production of CNA oligomers comprising the following method steps:
a) activation of the carboxyl function of a CNA monomer building block,
b) subsequent esterification of this monomer building block with a free hydroxyl function of the support under basic conditions and
c) thereafter assembly of the oligomer by repetitive cycles starting from elimination of the protective group on the amino group of the cyclohexyl ring of the CNA monomer and subsequent attachment of a further activated CNA monomer, employing CNA monomers of the formula (I) 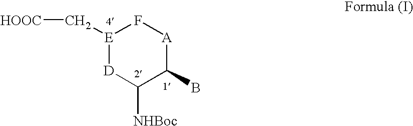
in which A, D and F may be, independently of one another, a —CR³R⁴—, —NR⁵—, —O— or —S— group and E may be a —CR⁶— group, where R³, R⁴, R⁵ or R⁶ may be, independently of one another, a hydrogen atom or a C₁-C₁₂-alkyl group, and in which B is a nucleobase whose primary amino groups may be in unprotected or Boc-protected form.

2. The method as claimed in claim 1, characterized in that the nucleobase B is selected from the group of adenine, guanine, cytosine, thymine, uracil, isoguanine, isocytosine, xanthine or hypoxanthine.

3. The method as claimed in claim 1, characterized in that CNA monomers selected from the group of 3-tert-butoxycarbonyl-1-[(1R,2R,4R)-2-tert-butoxycarbonylamino-4-carboxymethylcyclohex-1-yl]thymine (formula (II)), 1-[(1R,2R,4R)-2-tert-butoxycarbonylamino-4-carboxymethylcyclohex-1-yl]thymine (formula (III)), N⁶-tert-butoxycarbonyl-9-[(1R,2R,4R)-2-tert-butoxycarbonylamino-4-carboxymethylcyclohex-1-yl]adenine (formula (IV)), 9-[(1R,2R,4R)-2-tert-butoxycarbonylamino-4-carboxymethylcyclohex-1-yl]adenine (formula (V)), N⁴-tert-butoxycarbonyl-1-[(1R,2R,4R)-2-tert-butoxycarbonylamino-4-carboxymethylcyclohex-1-yl]cytosine (formula (VI)), 1-[(1R,2R,4R)-2-tert-butoxycarbonylamino-4-carboxymethylcyclohex-1-yl]cytosine (formula (VII)), N²-tert-butoxycarbonyl-9-[(1R,2R,4R)-2-tert-butoxycarbonylamino-4-carboxymethylcyclohex-1-yl]guanine (formula (VIII)), 9-[(1R,2R,4R)-2-tert-butoxycarbonylamino-4-carboxymethylcyclohex-1-yl]guanine (formula (IX)) are used.

4. The method as claimed in claim 1, characterized in that HATU, DIC, TBTU or HBTU is used for activating the carbonyl function of a CNA monomer building block.

5. The method as claimed in claim 1, characterized in that the CNA oligomer or the CNA monomer building block is additionally coupled to hydrophilic groups, markers or biologically active substances.

6. The method as claimed in claim 5, characterized in that phosphorylated butyric acid is used as linker for the coupling.

7. A method for the production of CNA monomers for CNA oligomer synthesis comprising the following method steps:
a) coupling of an iodolactam of the formula (XIII) 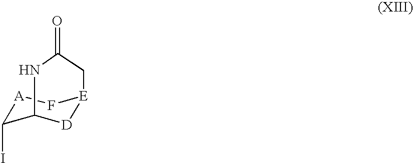
in which A, D and F may be independently of one another a —CR³R⁴— group and E may be a —CR⁶—, where R³, R⁴ or R⁶ have the abovementioned meaning, in the presence of a base to a nucleobase from the group of thymine, adenine, N⁶-benzoyladenine, N⁶-dimethylaminoethyleneadenine, cytosine, N⁴-benzoylcytosine or 2-amino-6-chloropurine,
b) subsequent protection of the nitrogen of the lactam ring with a Boc protective group and
c) nucleophilic ring cleavage to give the desired CNA monomer, with, in the case where 2-amino-6-chloropurine is used, the chlorine substituent being converted into a keto group.

8. The method as claimed in claim 7, characterized in that 8-iodo-2-azabicyclo[3.3.1]nonan-3-one is employed as iodolactam.

9. The method as claimed in claim 7, characterized in that the nucleophilic ring cleavage to give the CNA monomer is carried out with LiOH or LiOOH.

10. The method as claimed in claim 7, characterized in that the Boc protective groups are introduced through addition of di-tert-butyl pyrocarbonate in the presence of triethylamine and DMAP.

11. The method as claimed in claim 7 for the production of the thymine monomer, characterized in that a lithium salt of thymine is employed as precursor.

12. The method as claimed in claim 7 for the production of the guanine monomer, characterized in that the chlorine substituent is converted into a keto group in the presence of (CH₃)₃N, 3-OH-propionitrile and DBU.

13. The method of claim 7, characterized in that the CNA monomers produced are selected from the group consisting of 3-tert-butoxycarbonyl-1-[(1R,2R,4R)-2-tert-butoxycarbonyl-amino-4-carboxymethylcyclohex-1-yl]thymine (formula (II)), N⁶-tert-butoxycarbonyl-9-[(1R,2R,4R)-2-tert-butoxycarbonylamino-4-carboxymethylcyclohex-1-yl]adenine (formula (IV)), 9-[(1R,2R,4R)-2-tert-butoxycarbonylamino-4-carboxymethylcyclohex-1-yl]adenine (formula (V)), N⁴-tert-butoxycarbonyl-1-[(1R,2R,4R)-2-tert-butoxycarbonylamino-4-carboxymethylcyclohex-1-yl]cytosine (formula (VI)), 1-[(1R,2R,4R)-2-tert-butoxycarbonylamino-4-carboxymethylcyclohex-1-yl]cytosine (formula (VII)), N²-tert-butoxycarbonyl-9-[(1R,2R,4R)-2-tert-butoxycarbonylamino-4-carboxymethylcyclohex-1-yl]guanine (formula (VIII)), and 9-[(1R,2R,4R)-2-tert-butoxycarbonylamino-4-carboxymethylcyclohex-1-yl]guanine (formula (IX)).

14. Heteroduplexes comprising a CNA oligomer and a p-RNA oligomer complementary thereto.

15. Heteroduplexes as claimed in claim 14 comprising CNA oligomers having a 2′-4′-cyclohexyl-polyamide backbone.

16. Heteroduplexes as claimed in claim 14, characterized in that the CNA oligomers are assembled from monomers of the structural formula (XI), 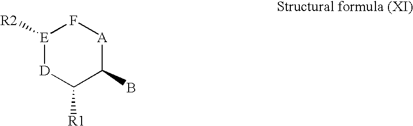
in which B is a nucleobase and R1 is an NH₂ group and R2 is a CH₂—COOH group, and A, D and F may independently of one another be a —CR³R⁴—, —NR⁵—, —O— or —S— group and E may be a —CR⁶— group, where R³, R⁴, R⁵ or R⁶ may be independently of one another a hydrogen atom or a C₁-C₁₂-alkyl group.

17. Heteroduplexes as claimed in claim 14 having the structural formula (XII) 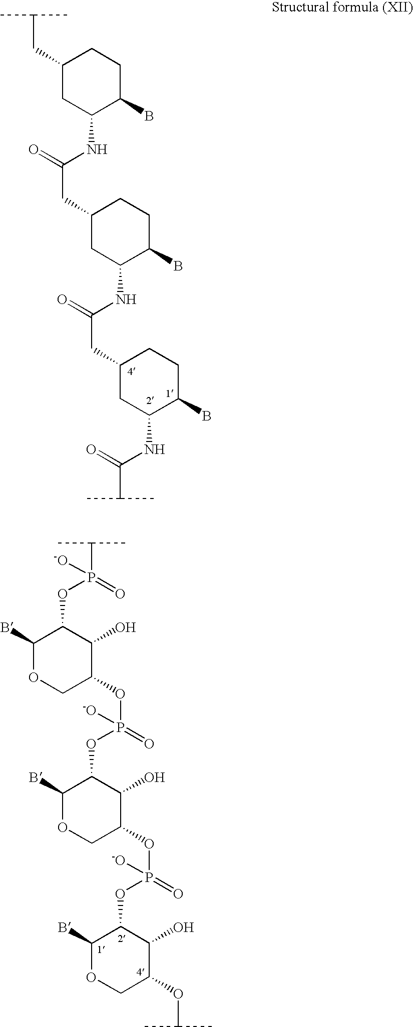
in which B and B′ are complementary nucleobase pairs.

18. Heteroduplexes as claimed in claim 14, characterized in that the CNA oligomer or the p-RNA oligomer is modified.

19. Heteroduplexes as claimed in claim 18, characterized in that the CNA oligomer and/or the p-RNA oligomer is modified with a peptide, a protein, a radioactive marker or a dye, and/or the CNA oligomer is modified with an N-terminal phosphate group.

20. Heteroduplexes as claimed in claim 18, characterized in that the modifications are terminal.

21. Heteroduplexes as claimed in claim 18, characterized in that N-terminal hydroxycarboxylic acid residues or terminal lysine residues are present as linkers on the CNA oligomer.

22. Modified CNA oligomers, characterized in that they are covalently linked to a fluorescent dye.

23. (Canceled)

24. (Canceled)
